(19) United States
(12) Patent Application Publication
(10) Pub. No.: US 2026/0136044 A1
(43) Pub. Date: May 14, 2026

(54) SELECTIVE APPLICATION OF NEURAL NETWORK BASED FILTERING TO PICTURE REGIONS

(71) Applicant: Telefonaktiebolaget LM Ericsson (publ), Stockholm (SE)

(72) Inventors: Martin PETTERSSON, Vallentuna (SE); Rickard SJÖBERG, Stockholm (SE); Jacob STRÖM, Stockholm (SE)

(73) Assignee: Telefonaktiebolaget LM Ericsson (publ), Stockholm (SE)

(21) Appl. No.: 19/119,179

(22) PCT Filed: Sep. 28, 2023
(86) PCT No.: PCT/SE2023/050956

§ 371 Date: Apr. 8, 2025

Related U.S. Application Data
(60) Provisional application No. 63/415,754, filed on Oct. 13, 2022.

(51) Int. Cl. H04N 19/70; H04N 19/117; H04N 19/167; H04N 19/172; H04N 19/85

(52) U.S. Cl. CPC H04N 19/70; H04N 19/117; H04N 19/167; H04N 19/172; H04N 19/85

(57) ABSTRACT

There is provided a method for processing a bitstream including a coded picture. The method comprises receiving the bitstream. The method comprises decoding the received bitstream including the coded picture, thereby obtaining i) a decoded picture, ii) filtering information about a first neural network, NN, based filtering, and iii) filtering area information indicating a first filtering area to which the first NN based filtering is to be applied. The method comprises applying the first NN based filtering to the first filtering area in the decoded picture. The received bitstream includes a group of one or more syntax elements that indicates that the first NN based filtering is to be applied to a first part of the decoded picture but is not to be applied to a second part of the decoded picture. The first filtering area corresponds to the first part of the decoded picture.

### TECHNICAL FIELD

Disclosed are embodiments related to selective application of neural network based filtering to picture regions.

### BACKGROUND

### Video and Picture

Versatile Video Coding (VVC) and its predecessor High Efficiency Video Coding (HEVC) are block-based video codecs standardized and developed jointly by International Telecommunication Union—Telecommunication (ITU-T) and Moving Picture Experts Group (MPEG). The codecs utilize both temporal and spatial prediction. VVC and HEVC are similar in many aspects. Spatial prediction is achieved using intra (I) prediction from within the current picture. Temporal prediction is achieved using uni-directional (P) or bi-directional inter (B) prediction on the block level from previously decoded reference pictures.

In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding”, in 2020. MPEG and ITU-T are working together within the Joint Video Exploratory Team (JVET) on updated versions of HEVC and VVC as well as the successor to VVC, i.e., the next generation video codec.

### Components

A video sequence consists of a series of pictures where each picture consists of one or more components. A picture in a video sequence is sometimes denoted ‘image’ or ‘frame’. Each component in a picture can be described as a two-dimensional rectangular array of sample values. It is common that a picture in a video sequence consists of three components; one luma component Y where the sample values are luma values and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### Blocks and Units

In many video coding standards, such as HEVC and VVC, each component is split into blocks and the coded video bitstream consists of a series of coded blocks. A block is a two-dimensional array of samples. It is common in video coding that the picture is split into units that cover a specific area of the picture. Each unit consists of all blocks from all components that make up that specific area and each block belongs fully to one unit. The macroblock in H.264 and the Coding unit (CU) in HEVC and VVC are examples of units.

A block can alternatively be defined as a two-dimensional array that a transform used in coding is applied to. These blocks are known under the name “transform blocks”. Alternatively, a block can be defined as a two-dimensional array that a single prediction mode is applied to. These blocks can be called “prediction blocks”. In this application, the word block is not tied to one of these definitions but that the descriptions herein can apply to either definition.

### VVC Block Structure

The VVC video coding standard uses a block structure referred to as quadtree plus binary tree plus ternary tree block structure (QTBT+TT) where each picture is first partitioned into square blocks called coding tree units (CTU). The size of all CTUs are identical and the partition is done without any syntax controlling it. Each CTU is further partitioned into coding units (CU) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. An example of dividing a CTU using QTBT is illustrated in FIGS. 10A and 10B. The ternary tree (TT) part adds the possibility to divide a CU into three partitions instead of two equally sized partitions; this increases the possibilities to use a block structure that better fits the content structure in a picture.

### Network Abstraction Layer (NAL) Units

Both VVC and HEVC define a Network Abstraction Layer (NAL). All the data, i.e., both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in VVC and HEVC begins with a header called the NAL unit header.

A compressed picture is referred to as a “coded picture”. In HEVC and VVC, a coded picture is a coded representation of a picture that consist of VCL NAL units only. A decoder can be said to decode a “coded picture” to a “picture” or to a “decoded picture”.

### Slices and Tiles

The concept of slices in HEVC divides the picture into independently coded slices, where decoding of one slice in a picture is independent of other slices of the same picture. Different coding types could be used for slices of the same picture, i.e., a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### Subpictures

Subpictures are supported in VVC where a subpicture is defined as a rectangular region of one or more slices within a picture. This means a subpicture contains one or more slices that collectively cover a rectangular region of a picture. In the VVC specification subpicture location and size are signaled in the SPS. Boundaries of a subpicture region may be treated as picture boundaries (excluding in-loop filtering operations) conditioned to a per-subpicture flag subpic_treated_as_pic_flag[i] in the SPS. Also loop-filtering on subpicture boundaries is conditioned to a per-subpicture flag loop_filter_across_subpic_enabled_flag[i] in the SPS.

Bitstream extraction and merge operations are supported through subpictures in VVC and could for instance comprise extracting one or more subpictures from a first bitstream, extracting one or more subpictures from a second bitstream and merging the extracted subpictures into a new third bitstream.

### Post-Filters

A post-filter is a filter that can be applied to the picture before it is displayed or otherwise further processed. A post-filter does not affect the contents of the decoded picture buffer (DPB), i.e., it does not affect the samples that future pictures are predicted from. Instead, it takes samples from the picture buffer and filters them before they are being displayed or further processed. As an example, such further processing can involve scaling the picture to allow it to be rendered in full-screen mode, reencoding the picture (this is known to a person skilled in the art as ‘transcoding’), using machine vision algorithms to extract information from the picture etc. Since a post-filter does not affect the prediction, doing post-filters a bit differently in every decoder does not give rise to drift. Hence it is often not necessary to standardize post-filters. In some codecs, the post-filter may be considered to be part of the decoder, and the samples output from the decoder are the samples output from the post-filter. In other codecs, the post-filter may be considered to be outside the decoder, and the samples output from the decoder are the samples that are inputted to the post-filter. In this document we are covering both cases.

### Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g., data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g., parameter sets) to be provided by external means. “By external means” should be interpreted as the information is not provided in the coded video bitstream but by some other means not specified in the video codec specification, e.g., via metadata possibly provided in a different data channel, as a constant in the decoder, or provided through an API to the decoder.

### Picture Header

In VVC, a coded picture comes with a picture header structure. The picture header structure contains syntax elements that are common for all slices of the associated picture. The picture header structure may be signaled in its own non-VCL NAL unit with NAL unit type PH_NUT or included in the slice header given that there is only one slice in the coded picture. This is indicated by the slice header syntax element picture_header_in_slice_header_flag, where a value equal to 1 specifies that the picture header structure is included in the slice header and a value equal to 0 specifies that the picture header structure is carried in its own PH NAL unit. For a CVS where not all pictures are single-slice pictures, each coded picture must be preceded by a picture header that is signaled in its own NAL unit. HEVC does not support picture headers.

### Supplementary Enhancement Information (SEI) Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI RBSP contains one or more SEI messages.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of SEI messages and is particularly intended for use with VVC, although it is written in a manner intended to be sufficiently generic that it may also be used with other types of coded video bitstreams. The first version of ITU-T H.274|ISO/IEC 23002-7 was finalized in July 2020. At the time of writing, version 3 is under development, and the most recent draft is JVET-AA2006-v2.

### Neural Networks for Image and Video Compression

A neural network consists of multiple layers of simple processing units called neurons or nodes which interact with each other via weighted connections and collectively create a powerful tool in the context of non-linear transforms and classification. Each node gets activated through weighted connections from previously activated nodes. To achieve non-linearity, a non-linear activation function is applied to the intermediate layers. A neural network architecture usually consists of an input layer, an output layer and one or more intermediate layers, each of which contains various numbers of nodes.

Neural network-based techniques for image and video coding and compression have been explored especially after the introduction of convolutional neural networks (CNNs) which provide a reasonable trade-off between the number of the neural network model parameters and trainability of the neural network model. CNNs have a smaller number of parameters compared to fully connected neural networks which makes the large-scale neural network training possible.

Currently, there are two main technological development tracks for using neural networks for image and video compression: One track is integrating neural networks to an existing codec by replacing one or more of the modules in the existing block-based image and video coding standards with a neural network model to improve the coding efficiency, and another track is the end-to-end track which replaces the entire codec with a neural network module with the possibility for end-to-end training and optimization.

Neural Network-Based Post-Filters Indicated with SEI Message

The current draft of version 3 of ITU-T H.274|ISO/IEC 23002-7, also referred to as VSEI, comprises two SEI messages for signaling parameters for a NN post-filter process to be applied to the decoded pictures of the video.

The first SEI message, the NN post-filter characteristics SEI message, contains a neural network post-filter signaled using the MPEG Neural Network Representation (NNR, ISO/IEC 15938-17) standard, alternatively references a URL where the parameters for the NN post-filter can be fetched.

The second SEI message, the NN post-filter activation SEI message, is sent for the pictures where the NN post-filter specified in the NN post-filter characteristics SEI message is to be applied. The NN post-filter activation SEI message references a specific NN post-filter characteristics SEI message using a unique identifier specified with the nnpfc_id and nnpfa_id syntax elements in the two SEI messages.

The NN post-filter activation SEI message is much smaller than the NN post-filter characteristics SEI message, meaning that the post-filter activation SEI message saves many bits compared to if the NN post-filter characteristics SEI message should be sent for each picture where the NN post-filter should be applied.

Syntax and relevant semantics for the two NN SEI messages from the version 3 draft of VSEI in JVET-AA2006v2, is shown below.

### Neural-Network Post-Filter Characteristics SEI Message

| | Descriptor |
|---|---|
| nn_post_filter_characteristics( payloadSize ) { | |
| nnpfc_{—}id | ue(v) |
| nnpfc_{—}mode_{—}idc | ue(v) |
| nnpfc_{—}purpose_{—}and_{—}formatting_{—}flag | u(1) |
| if( nnpfc_purpose_and_formatting_flag ) { | |
| nnpfc_{—}purpose | ue(v) |
| if( nnpfc_purpose = = 2 \| \| nnpfc_purpose = = 4 ) | |
| nnpfc_{—}out_{—}sub_{—}c_{—}flag | u(1) |
| if( nnpfc_purpose = = 3 \| \| nnpfc_purpose = = 4 ) { | |
| nnpfc_{—}pic_{—}width_{—}in_{—}luma_{—}samples | ue(v) |
| nnpfc_{—}pic_{—}height_{—}in_{—}luma_{—}samples | ue(v) |
| } | |
| /* input and output formatting */ | |
| nnpfc_{—}component_{—}last_{—}flag | u(1) |
| nnpfc_{—}inp_{—}format_{—}flag | u(1) |
| if( nnpfc_inp_format_flag = = 1 ) | |
| nnpfc_{—}inp_{—}tensor_{—}bitdepth_{—}minus8 | ue(v) |
| nnpfc_{—}inp_{—}order_{—}idc | ue(v) |
| nnpfc_{—}auxiliary_{—}inp_{—}idc | ue(v) |
| nnpfc_{—}separate_{—}colour_{—}description_{—}present_{—}flag | u(1) |
| if( nnpfc_separate_colour_description_present_flag ) { | |
| nnpfc_{—}colour_{—}primaries | u(8) |
| nnpfc_{—}transfer_{—}characteristics | u(8) |
| nnpfc_{—}matrix_{—}coeffs | u(8) |
| } | |
| nnpfc_{—}out_{—}format_{—}flag | u(1) |
| if( nnpfc_out_format_flag = = 1 ) | |
| nnpfc_{—}out_{—}tensor_{—}bitdepth_{—}minus8 | ue(v) |
| nnpfc_{—}out_{—}order_{—}idc | ue(v) |
| nnpfc_{—}constant_{—}patch_{—}size_{—}flag | u(1) |
| nnpfc_{—}patch_{—}width_{—}minus1 | ue(v) |
| nnpfc_{—}patch_{—}height_{—}minus1 | ue(v) |
| nnpfc_{—}overlap | ue(v) |
| nnpfc_{—}padding_{—}type | ue(v) |
| if( nnpfc_padding_type = = 4 ){ | |
| nnpfc_{—}luma_{—}padding_{—}val | ue(v) |
| nnpfc_{—}cb_{—}padding_{—}val | ue(v) |
| nnpfc_{—}cr_{—}padding_{—}val | ue(v) |
| } | |
| nnpfc_{—}complexity_{—}idc | ue(v) |
| if( nnpfc_complexity_idc > 0 ) | |
| nnpfc_complexity_element( nnpfc_complexity_idc ) | |
| if( nnpfc_mode_idc = = 2 ) { | |
| while( !byte_aligned( ) ) | |
| nnpfc_{—}reserved_{—}zero_{—}bit | u(1) |
| nnpfc_{—}uri_{—}tag[ i ] | st(v) |
| nnpfc_{—}uri[ i ] | st(v) |
| } | |
| } | |
| /* filter specified or updated by ISO/IEC 15938-17 bitstream */ | |
| if( nnpfc_mode_idc = = 1 ) { | |
| while( !byte_aligned( ) ) | |
| nnpfc_{—}reserved_{—}zero_{—}bit | u(1) |
| for( i = 0; more_data_in_payload( ); i++ ) | |
| nnpfc_{—}payload_{—}byte[ i ] | b(8) |
| } | |
| } | |

nnpfc_id contains an identifying number that may be used to identify a post-processing filter. The value of nnpfc_id shall be in the range of 0 to 2³²-2, inclusive. Values of nnpfc_id from 256 to 511, inclusive, and from 2³¹ to 2³²-2, inclusive, are reserved for future use by ITU-T|ISO/IEC. Decoders encountering a value of nnpfc_id in the range of 256 to 511, inclusive, or in the range of 2³¹ to 2³²-2, inclusive, shall ignore it.

nnpfc_mode_idc equal to 0 specifies that the post-processing filter associated with the nnpfc_id value is determined by external means not specified in this Specification. nnpfc_mode_idc equal to 1 specifies that the post-processing filter associated with the nnpfc_id value is a neural network represented by the ISO/IEC 15938-17 bitstream contained in this SEI message. nnpfc_mode_idc equal to 2 specifies that the post-processing filter associated with the nnpfc_id value is a neural network identified by a specified tag Uniform Resource Identifier (URI) (nnpfc_uri_tag[i]) and neural network information URI (nnpfc_uri[i]). The value of nnpfc_mode_idc shall be in the range of 0 to 255, inclusive. Values of nnpfc_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnpfc_mode_idc.

nnpfc_purpose indicates the purpose of post-processing filter as specified in Table 20. The value of nnpfc_purpose shall be in the range of 0 to 2³²-2, inclusive. Values of nnpfc_purpose that do not appear in Table 20 are reserved for future specification by ITU-T|ISO/IEC and shall not be present in bitstreams conforming to this version of this Specification. Decoders conforming to this version of this Specification shall ignore SEI messages that contain reserved values of nnpfc_purpose.

Definition of nnpfc_purpose

| Value | Interpretation |
|---|---|
| 0 | Unknown or unspecified |
| 1 | Visual quality improvement |
| 2 | Chroma upsampling from the 4:2:0 chroma |
| | format to the 4:2:2 or 4:4:4 chroma format, |
| | or from the 4:2:2 chroma format to the |
| | 4:4:4 chroma format |
| 3 | Increasing the width or height of the cropped |
| | decoded output picture without changing |
| | the chroma format |
| 4 | Increasing the width or height of the cropped |
| | decoded output picture and upsampling |
| | the chroma format |

### Neural-Network Post-Filter Activation SEI Message Syntax

| | Descriptor |
|---|---|
| nn_post_filter_activation( payloadSize ) { | |
| nnpfa_{—}id | ue(v) |
| } | |

This SEI message specifies the neural-network post-processing filter that may be used for post-processing filtering for the current picture.

The neural-network post-processing filter activation SEI message persists only for the current picture. NOTE—There can be several neural-network post-processing filter activation SEI messages present for the same picture, for example, when the post-processing filters are meant for different purposes or filter different colour components.

nnpfa_id specifies that the neural-network post-processing filter specified by one or more neural-network post-processing filter characteristics SEI messages that pertain to the current picture and have nnpfc_id equal to nnfpa_id may be used for post-processing filtering for the current picture.

### Scalable Nesting SEI Message

The scalable nesting SEI message in VVC provides a mechanism to associate SEI messages with specific OLSs, specific layers, or specific sets of subpictures. A scalable nesting SEI message contains one or more SEI messages. The SEI messages contained in the scalable nesting SEI message are also referred to as the scalable-nested SEI messages. The scalable nesting SEI message syntax in VVC is shown in the table provided below.

### Scalable Nesting SEI Message Syntax in VVC

| | Descriptor |
|---|---|
| scalable_nesting( payloadSize ) { | |
| sn_{—}ols_{—}flag | u(1) |
| sn_{—}subpic_{—}flag | u(1) |
| if( sn_ols_flag ) { | |
| sn_{—}num_{—}olss_{—}minus1 | ue(v) |
| for( i = 0; i <= sn_num_olss_minus1; i++ ) | |
| sn_{—}ols_{—}idx_{—}delta_{—}minus1[ i ] | ue(v) |
| } else { | |
| sn_{—}all_{—}layers_{—}flag | u(1) |
| if( !sn_all_layers_flag ) { | |
| sn_{—}num_{—}layers_{—}minus1 | ue(v) |
| for( i = 1; i <= sn_num_layers_minus1; i++ ) | |
| sn_{—}layer_{—}id[ i ] | u(6) |
| } | |
| } | |
| if( sn_subpic_flag ) { | |
| sn_{—}num_{—}subpics_{—}minus1 | ue(v) |
| sn_{—}subpic_{—}id_{—}len_{—}minus1 | ue(v) |
| for( i = 0; i <= sn_num_subpics_minus1; i++ ) | |
| sn_{—}subpic_{—}id[ i ] | u(v) |
| } | |
| sn_{—}num_{—}seis_{—}minus1 | ue(v) |
| while( !byte_aligned( ) ) | |
| sn_{—}zero_{—}bit /* equal to 0 */ | u(1) |
| for( i = 0; i <= sn_num_seis_minus1; i++ ) | |
| sei_message( ) | |
| } | |

### MPEG Systems and Relevant Specifications

The MPEG systems group in MPEG develops systems standards for storing, transporting and presenting compressed media, including traditional video such as single layer HEVC and VVC encoded bitstreams, and immersive audio and video including 360 video and point clouds. This includes packetizing the compressed media, attaching appropriate metadata and make relevant information available to the systems and application layers, including network nodes and media players. Standards developed by the MPEG systems group relevant for this invention include the following specifications.

### ISO Base Media File Format

The ISO Base Media File Format (ISOBMFF) specified in ISO/IEC 14496-12 defines a base file structure for storing and transporting media, including audio and video. A file based on the ISOBMFF has a logical structure with a so-called movie comprising one or more time-parallel tracks where each track is a media stream. The tracks contain sequences of samples in time, where each sample can have a decoding time, a composition time and a presentation time. For video, a sample corresponds to a picture. Each track has a specific media type (audio, video, etc.), and is further parameterized by a sample entry, including the identifier of the media type used (e.g. the video codec). Each sample in a track may be associated with a sample group, where a sample group is grouping samples with a specific property, e.g. all samples in the group being random access samples. The physical structure of an ISOBMFF file is a series of specific defined boxes (sometimes called atoms), in a hierarchical setup, with the boxes describing the properties of the media for the movie and for each track. Each box has a length, type, flags and data. The media data for the samples, e.g., the compress video bitstream, is stored unstructured in ‘mdat’ or ‘idat’ boxes in the same file or in a separate file.

Many of the MPEG systems specifications inherits structures and boxes from ISOBMFF, including MPEG-DASH, Carriage of NAL unit structured video in the ISOBMFF, Omnidirectional Application Format (OMAF) and the Carriage of PCC data.

### Carriage of NAL Unit Structured Video in the ISOBMFF

The Carriage of NAL unit structured video in the ISOBMFF specified in ISO/IEC 14496-15 specifies the storage format for video streams encoded with AVC, HEVC and VVC. This includes definitions of how to derive from the ISOBMFF, the sample groups to use for the different random access types, entity groups to be used for subpictures and operating points, and how to packetize layers into different tracks.

### MPEG-DASH

MPEG-DASH (Dynamic Adaptive Streaming over HTTP) specified in ISO/IEC 23009 is an adaptive bitrate streaming technology where a multimedia file is partitioned into one or more segments and delivered to a client using HTTP, typically over TCP. An MPEG-DASH session is set-up using a media presentation description (MPD)) that describes segment information including timing, URL and media characteristics like video resolution and bit rates. MPDs, which are XML-based, can be static, e.g., for movies, or dynamic, such as for live content. Segments can contain any media data, however the specification provides specific guidance and formats for use with two types of containers: ISO base media file format or MPEG-2 Transport Stream. One or more representations of multimedia files, e.g., versions at different resolutions or bit rates, are typically available, and selection can be made based on network conditions, device capabilities and user preferences, enabling adaptive bitrate streaming.

### Media Transport in IETF

The Internet Engineering Task Force (IETF) have developed a number of protocols for media transport and media session setup. Some of these protocols are described below.

### Real-Time Transport Protocol

The Real-time Transport Protocol (RTP) specified in RFC 3550 is a network protocol for sending audio and video over IP networks. RTP is typically used in communication and entertainment systems that involve streaming media, such as telephony, video teleconference applications including WebRTC, IPTV and web-based push-to-talk features. RTP is typically run over User Datagram Protocol (UDP) and often together with the RTP Control Protocol (RTCP) that monitors transmission statistics and quality of service (QoS). The information provided by RTP includes timestamps (for synchronization), sequence numbers (for packet loss and reordering detection) and the payload format which indicates the encoded format of the data. The Real-Time Streaming protocol (RTSP) is a network protocol used for controlling streaming media servers. Media clients sends commands such as play, skip and pause to the media server to facilitate control of media streaming from the server to the client, also referred to as Video on Demand.

RTP is designed to carry a multitude of multimedia formats, which permits the development of new formats without revising the RTP standard. RTP therefore defines profiles and associated payload formats. Examples of RTP profiles include the RTP Profile for Audio and Video (RTP/AVP) specified in RFC 3551 and the Secure Real-time Transport Protocol (SRTP) for encrypting transfer of payload data specified in RFC 3711. RTP payload formats specify how certain media formats, e.g. media encoded with certain codecs, are packetized and transported. RTP payload formats have been specified for a number of audio, video and picture codecs, including H.264 (RFC 6184), HEVC (RFC 7798), JPEG (RFC 2435) and JPEG XS (RFC 9134). The development of the RTP payload format for VVC is ongoing in IETF.

### Session Description Protocol

The Session Description Protocol (SDP) specified in RFC 8866 is a format for describing multimedia communication sessions for the purposes of setting up a connection. Its predominant use is in support of streaming media applications, such as voice over IP (VOIP) and video conferencing. SDP does not deliver any media streams itself but is used between endpoints for negotiation of network metrics, media types, and other associated properties. The set of properties and parameters is called a session profile. SDP is typically used in conjunction with RTP, RTSP, the Session Initiation Protocol (SIP), and as a standalone protocol for describing multicast sessions.

### SUMMARY

Certain challenges presently exist. For example, even though, in the two neural network (NN) post-filter supplementary enhancement information (SEI) messages in the draft version 3 of versatile SEI (VSEI), it may be possible to turn on and off applying an NN post-filtering per picture, it is not possible to turn on and off applying the NN post-filtering per region, which is smaller than a subpicture.

However, there may be a need to apply an NN post-filtering only to certain regions of a picture. For example, certain types of content within a picture (e.g., grass) may benefit from application of a certain type of NN post-filtering while other types of content (e.g., sky, cartoon, or other easy coded content) may benefit from application another type of NN post-filtering or no application of any NN post-filtering at all.

As discussed above briefly, a scalable nesting SEI message provides a method for applying an SEI message to one or more subpictures of a picture. Although this nesting SEI message can be used to apply an NN post-filtering per subpicture, it may be desirable to be able to apply an NN post filtering per region of various sizes (e.g., a region that is smaller than a subpicture) to further improve quality of a decoded picture (especially when the content of the picture is very different in various parts of the picture). Furthermore, dividing the picture into subpictures in order to selectively apply an NN post-filtering to each subpicture would significantly decrease coding efficiency for compressing the picture since a subpicture is independently decodable and is not allowed to be predicted from spatial areas outside its own borders. Therefore, there is a need to allow selectively applying NN post-filtering(s) to certain regions (a.k.a., areas) of a decoded picture.

Accordingly, in one aspect of the embodiments of this disclosure, there is provided a method for processing a bitstream including a coded picture. The method comprises receiving the bitstream; decoding the received bitstream including the coded picture, thereby obtaining i) a decoded picture, ii) filtering information about a first neural network, NN, based filtering, and iii) filtering area information indicating a first filtering area to which the first NN based filtering is to be applied; and applying the first NN based filtering to the first filtering area in the decoded picture.

The received bitstream includes a group of one or more syntax elements that indicates that the first NN based filtering is to be applied to a first part of the decoded picture but is not to be applied to a second part of the decoded picture. The first filtering area corresponds to the first part of the decoded picture.

In another aspect, there is provided a method performed by an encoder. The method comprises obtaining a picture; obtaining filtering information about a first neural network, NN, based filtering; obtaining filtering area information indicating a first filtering area within the picture, to which the first NN based filtering is to be applied; and encoding the picture, the filtering information, and the filtering area information, thereby generating a bitstream including a coded picture.

In another aspect, there is provided a computer program comprising instructions (944) which when executed by processing circuitry cause the processing circuitry to perform the method of any one of embodiments described above.

In another aspect, there is provided a carrier containing the computer program of the above embodiment, wherein the carrier is one of an electronic signal, an optical signal, a radio signal, and a computer readable storage medium.

In another aspect, there is provided an apparatus for processing a bitstream including a coded picture. The apparatus is configured to receive the bitstream; decode the received bitstream including the coded picture, thereby obtaining i) a decoded picture, ii) filtering information about a first neural network, NN, based filtering, and iii) filtering area information indicating a first filtering area to which the first NN based filtering is to be applied; and apply the first NN based filtering to the first filtering area in the decoded picture. The received bitstream includes a group of one or more syntax elements that indicates that the first NN based filtering is to be applied to a first part of the decoded picture but is not to be applied to a second part of the decoded picture. The first filtering area corresponds to the first part of the decoded picture.

In another aspect, there is provided an encoder. The encoder is configured to obtain a picture; obtain filtering information about a first neural network, NN, based filtering; obtain filtering area information indicating a first filtering area within the picture, to which the first NN based filtering is to be applied; and encode the picture, the filtering information, and the filtering area information, thereby generating a bitstream including a coded picture.

In another aspect, there is provided an apparatus. The apparatus comprises a processing circuitry; and a memory, said memory containing instructions executable by said processing circuitry, whereby the apparatus is operative to perform the method of any one of embodiments described above.

Embodiments of this disclosure allow applying an NN-based filtering to a picture region, which is different from a picture or a subpicture. Also, the embodiments allow applying different NN-based filtering to different picture regions.

The accompanying drawings, which are incorporated herein and form part of the specification, illustrate various embodiments.

### BRIEF DESCRIPTION OF THE DRAWINGS

FIG. 1A shows a system according to some embodiments.

FIG. 1B shows a system according to some embodiments.

FIG. 1C shows a system according to some embodiments.

FIG. 2 shows a schematic block diagram of an encoder according to some embodiments.

FIG. 3 shows a schematic block diagram of a decoder according to some embodiments.

FIG. 4 shows an example bitstream.

FIG. 5 shows a size relationship between a patch, an active region, or an inactive region.

FIG. 6A shows regions defined by rows and columns.

FIG. 6B shows a bitstream according to some embodiments.

FIG. 7 shows a process according to some embodiments.

FIG. 8 shows a process according to some embodiments.

FIG. 9 shows an apparatus according to some embodiments.

FIGS. 10A and 10B show a method of dividing a coding tree unit.

### DETAILED DESCRIPTION

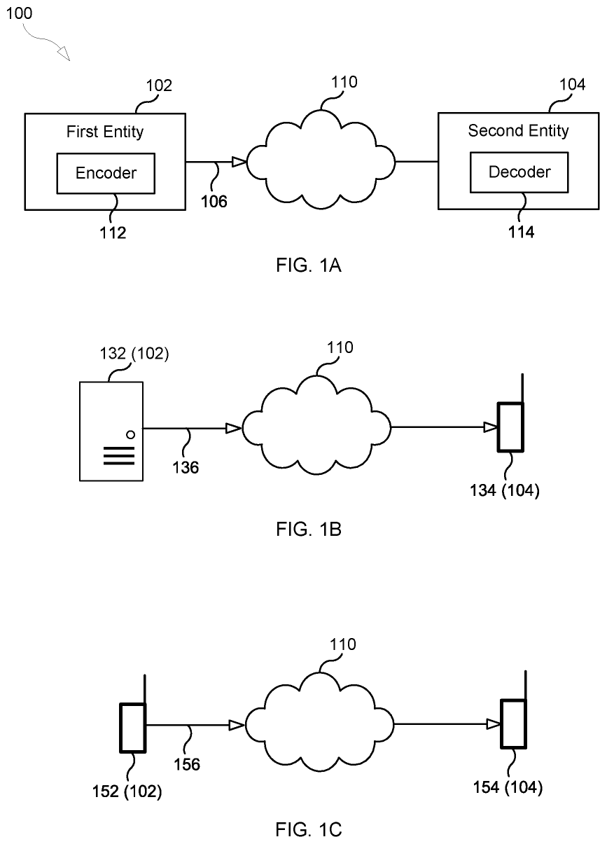

FIG. 1A shows a system 100 according to some embodiments. System 100 comprises a first entity 102, a second entity 104, and a network 110. First entity 102 is configured to transmit towards second entity 104 a video stream (a.k.a., “a video bitstream” or “a bitstream”) 106 via network 110.

First entity 102 may be any computing device (e.g., a network node such as a server) capable of encoding a video using an encoder 112 and transmitting the encoded video towards second entity 104 via network 110. Like first entity 102, second entity 104 may be any computing device (e.g., a network node) capable of receiving the encoded video and decoding the encoded video using a decoder 114. The second entity 104 may also apply a post-filter process to the decoded picture. Each of first entity 102 and second entity 104 may be a single physical entity or a combination of multiple physical entities. The multiple physical entities may be located in the same location or may be distributed in a cloud.

In some embodiments, as shown in FIG. 1B, first entity 102 is a video streaming server 132 and second entity 104 is a user equipment (UE) 134. UE 134 may be any of a desktop, a laptop, a tablet, a mobile phone, or any other computing device capable of decoding a bitstream. Video streaming server 132 is capable of transmitting a bitstream 136 (e.g., YouTube™ video streaming) towards UE 134 (i.e., a video streaming client). Upon receiving the bitstream 136, UE 134 may decode the received bitstream 136, thereby generating and displaying a video for the video streaming.

In other embodiments, as shown in FIG. 1C, first entity 102 and second entity 104 are first and second UEs 152 and 154. For example, first UE 152 may be an offeror of a video conferencing session or a caller of a video chat, and second UE 154 may be an answerer of the video conference session or the answerer of the video chat. In the embodiments shown in FIG. 1C, first UE 152 is capable of transmitting a bitstream 156 for a video conference (e.g., Zoom™, Skype™, MS Teams™, etc.) or a video chat (e.g., Facetime™) towards second UE 154. Upon receiving video bitstream 156, second UE 154 may decode the received bitstream 156, thereby generating and displaying a video for the video conferencing session or the video chat.

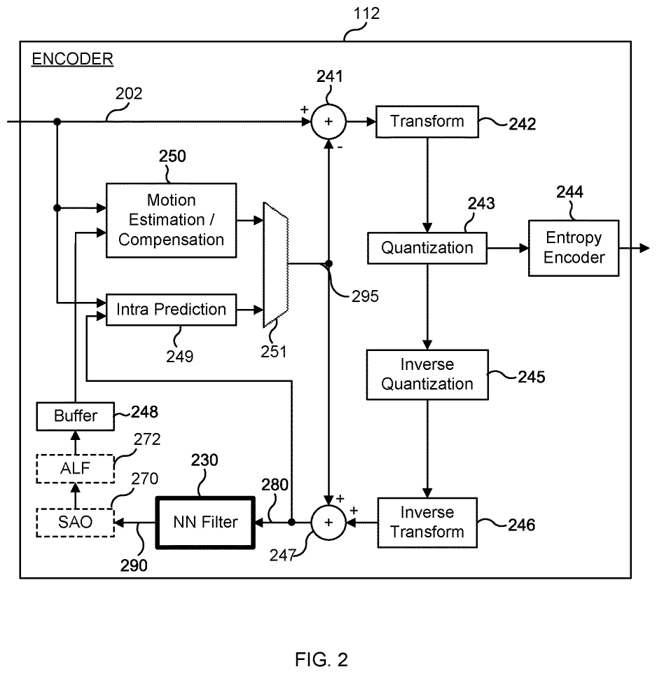

FIG. 2 shows a schematic block diagram of encoder 112 according to some embodiments. Encoder 112 is configured to encode a block of sample values (hereafter “block”) in a video frame of a source video 202. In encoder 112, a current block (e.g., a block included in a video frame of source video 202) is predicted by performing a motion estimation by a motion estimator 250 from an already provided block in the same frame or in a previous frame. The result of the motion estimation is a motion or displacement vector associated with the reference block, in the case of inter prediction. The motion vector is utilized by motion compensator 250 for outputting an inter prediction of the block.

An intra predictor 249 computes an intra prediction of the current block. The outputs from motion estimator/compensator 250 and intra predictor 249 are inputted to a selector 251 that either selects intra prediction or inter prediction for the current block. The output from selector 251 is input to an error calculator in the form of an adder 241 that also receives the sample values of the current block. Adder 241 calculates and outputs a residual error as the difference in sample values between the block and its prediction. The error is transformed in a transformer 242, such as by a discrete cosine transform, and quantized by a quantizer 243 followed by coding in an encoder 244, such as by entropy encoder. In inter coding, the estimated motion vector is brought to encoder 244 for generating the coded representation of the current block.

The transformed and quantized residual error for the current block is also provided to an inverse quantizer 245 and an inverse transformer 246 to retrieve the original residual error. This error is added by an adder 247 to the block prediction output from motion compensator 250 or intra predictor 249 to create a reconstructed sample block 280 that can be used in the prediction and coding of a next block. Reconstructed sample block 280 is processed by an NN filter 230 according to the embodiments in order to perform filtering to combat any blocking artifact. The output from NN filter 230, i.e., output data 290, is then temporarily stored in a frame buffer 248, where it is available to intra predictor 249 and motion estimator/compensator 250.

In some embodiments, encoder 112 may include sample adaptive offsets (SAO) unit 270 and/or adaptive loop filter (ALF) 272. SAO unit 270 and ALF 272 may be configured to receive output data 290 from NN filter 230, perform additional filtering on output data 290, and provide the filtered output data to buffer 248.

Even though, in the embodiments shown in FIG. 2, NN filter 230 is disposed between SAO unit 270 and adder 247, in other embodiments, NN filter 230 may replace SAO unit 270 and/or ALF 272. Alternatively, in other embodiments, NN filter 230 may be disposed between buffer 248 and motion compensator 250. Furthermore, in some embodiments, a deblocking filter (not shown) may be disposed between NN filter 230 and adder 247 such that reconstructed sample block 280 goes through the deblocking process and then is provided to NN filter 230.

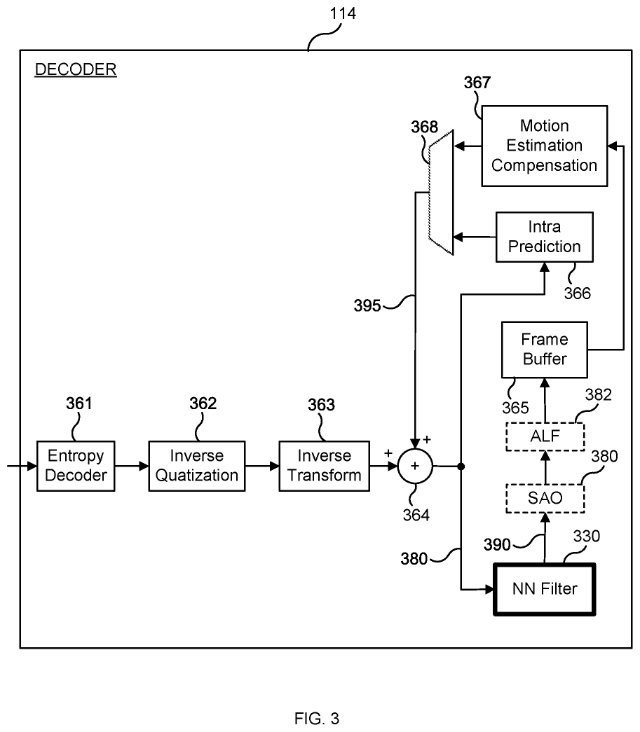

FIG. 3 is a schematic block diagram of decoder 114 according to some embodiments. Decoder 114 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the sample values of a reference block. The reference block is determined by a motion estimator/compensator 367 or intra predictor 366, depending on whether inter or intra prediction is performed.

A selector 368 is thereby interconnected to adder 364 and motion estimator/compensator 367 and intra predictor 366. Resulting decoded block 380 output form adder 364 is input to an NN filter unit 330 according to the embodiments in order to filter any blocking artifacts. Filtered block 390 is output form NN filter 330 and is furthermore preferably temporarily provided to a frame buffer 365 and can be used as a reference block for a subsequent block to be decoded.

Frame buffer (e.g., decoded picture buffer (DPB)) 365 is thereby connected to motion estimator/compensator 367 to make the stored blocks of samples available to motion estimator/compensator 367. The output from adder 364 is preferably also input to intra predictor 366 to be used as an unfiltered reference block.

In some embodiments, decoder 114 may include SAO unit 380 and/or ALF 372. SAO unit 380 and ALF 382 may be configured to receive output data 390 from NN filter 330, perform additional filtering on output data 390, and provide the filtered output data to buffer 365.

Even though, in the embodiments shown in FIG. 3, NN filter 330 is disposed between SAO unit 380 and adder 364, in other embodiments, NN filter 330 may replace SAO unit 380 and/or ALF 382. Alternatively, in other embodiments, NN filter 330 may be disposed between buffer 365 and motion compensator 367. Furthermore, in some embodiments, a deblocking filter (not shown) may be disposed between NN filter 330 and adder 364 such that reconstructed sample block 380 goes through the deblocking process and then is provided to NN filter 330.

As explained above, there is a need to allow selectively applying NN post-filtering(s) to certain regions (a.k.a., areas) of a decoded picture.

Therefore, according to some embodiments of this disclosure, filtering information about a filter operation (a.k.a., NN-based filtering, NN post filtering) of NN filter unit (a.k.a., NN-based filter or NN post filter) 330 included in decoder 114 and/or filtering area information indicating a filtering area to which the filtering operation of NN filter unit 330 is to be applied are signalled in bitstream 106/136/156 (herein after, “the bitstream”).

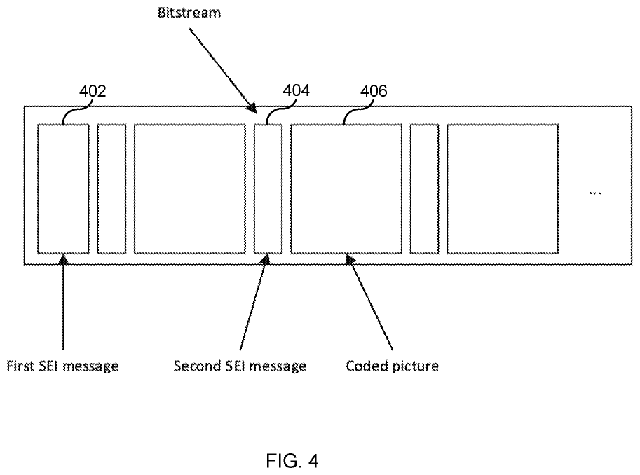

FIG. 4 shows contents of the bitstream according to some embodiments. As shown in FIG. 4, the bitstream may comprise a first SEI message 402, a second SEI message 404, and a coded picture 406. First SEI message 402 may include the filtering information about the NN-based filtering, and second SEI message 404 may include the filtering area information indicating the filtering area. An example of first SEI message 402 is an NN post-filter characteristic SEI message and an example of second SEI message 402 is an NN post-filter activation SEI message.

First SEI message 402 may comprise a first set of syntax elements, and decoding the first set of syntax elements may result in obtaining the filtering information. Similarly, second SEI message 404 may comprise a second set of syntax elements, and decoding the second set of syntax elements may result in obtaining the filtering area information. Similarly, decoding the third set of syntax elements may result in obtaining the decoded picture.

In some embodiments, the filtering area (i.e., the filtering region) is a rectangular area within the decoded picture. The filtering area may be defined by its width, height, and vertical and horizontal positions of at least one corner of the filtering area (e.g., the position of the top-left corner). However, in other embodiments, the filtering area is i) a non-rectangular area (e.g., an L-shaped area) consisting of coding tree units (CTUs) or ii) an area having the shape of a circle, triangle, etc. The filtering area may be a single shape, or may be a compound or disjunct of rectangular shapes or other shapes.

In case the filtering area is a compound of multiple shapes, the shapes may overlap. For example, two rectangular shapes may form a non-rectangular shape. However, in other embodiments, the shapes do not overlap. For example, the shapes may collectively cover the whole picture while they do not overlap each other.

In some embodiments, both the region width of a region and the region height of the region are equal to 1, meaning that the region corresponds to a sample (e.g., a luma sample) in the picture. Each sample (e.g., a luma sample) in a picture may correspond to a region, and the set of regions for the picture can be expressed with a map having a resolution that is same as the resolution of the picture. In the case the values of the map indicate whether each region uses the NN post-filter or not, a binary map, or binary mask, would be sufficient.

In some embodiments, the number of regions in a picture is limited to a specific number. The region height and/or the region width may not be smaller than a certain number (e.g., 16). Additionally or alternatively, the region width and/or the region height may be a multiple of a certain number, e.g. 16.

The size and position of the filtering area may be specified in relation to the input to the NN-based filter, i.e., the decoded picture. Alternatively, the size and position of the filtering area may be specified in relation to the output to the NN-based filter, i.e., the decoded picture.

Further alternatively, the size and position of the filtering area may be specified both in relation to the input to the NN-based filter and in relation to output from the NN-based filter.

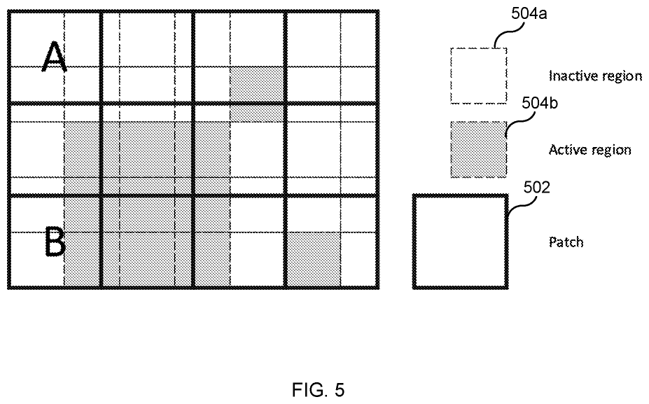

An NN-based filtering is typically applied to several patches, where a patch (a.k.a., NN patch) is a specific area to which one part of the NN-based filtering is applied. In some embodiments, the borders of the filtering area align with the borders of the NN patch. However, in other embodiments, the borders of the filtering area do not align with the borders of the NN patch (meaning that the filtering area or patches don't have to be equally sized, and the filtering areas may be larger than patches). FIG. 5 illustrates these embodiments.

FIG. 5 shows an exemplary grid of equally sized patches 502 in solid lines and equally sized regions 504a and 504b in dashed lines where the grey regions 504b are active regions to which the NN post filtering should be applied.

As discussed above, in some embodiments, a filtering area may be defined in relationship to the output samples of the NN post-filtering. The NN post-filtering may only need to be applied for the patches which are part of a region. This means that the input samples to the

NN post-filtering may contain parts of regions to which the NN post-filtering is not to be applied but the output samples of the filter are the only output for the areas covered by the regions for which the NN post-filter is to be applied. Other areas may use the input samples as output.

For example, in FIG. 5, the NN post-filtering doesn't need to be applied to the upper left patch A but needs to be applied to the bottom left patch B since the patch B overlaps with parts of the filtering area (i.e., the active region). The output samples from the NN post-filtering only correspond to the part of the patch B which overlaps the filtering area (i.e., the active regions). Other parts of the patch B which do not overlap the filtering area outputs the input samples. In other embodiments, the area of the patch which is not covered by a region to which the NN post-filter is to be applied is padded, for example, by extrapolating the bordering pixels values, with or without a smoothing filter.

The NN post-filtering may be used for any one of more of the following purposes: visual quality improvement, providing a super-resolution, picture upsampling, and chroma format upsampling.

Upon receiving the bitstream, according to some embodiments, decoder 114 may perform all of or a subset of the following steps in order to decode a coded picture from the bitstream and apply an NN-post filtering (NN-based filtering) to a filtering region of a decoded picture.
1. Decoder 114 decodes the coded picture 406 corresponding to a first set of syntax elements in the bitstream, to obtain a decoded picture.
2. Decoder 114 decodes a second set of syntax elements included in the bitstream to obtain the filtering information specifying a first NN post-filter process. As discussed above, the second set of syntax elements may be signaled in an SEI message (e.g., first SEI message 402). In one example, the SEI message is an NN post-filter characteristics SEI message.
3. Decoder 114 decodes a third set of syntax elements from the bitstream to obtain the filtering area information indicating a filtering area to which the first NN post-filter process is to be applied. The third set of syntax element may comprise one or more syntax elements.
4. Decoder 114 determines from the one or more syntax elements of the third set of syntax elements that the first NN post-filter is to be applied to at least a first region in the decoded picture and not to be applied to at least a second region in the decoded picture. The third set of syntax elements may be signaled in an SEI message (e.g., the second SEI message 404). In one example, the SEI message is an NN post-filter activation SEI message.
5. Decoder 114 applies the first NN post-filter process to the at least first region in the decoded picture without applying it to the at least second region in the decoded picture.

In generating the bitstream, according to some embodiments, encoder 112 may perform all of or a subset of the following steps in order to encode a picture and information related to how to apply an NN post-filtering to a filtering area.
1. Encoder 112 encodes a picture to a first set of syntax elements in the bitstream.
2. Encoder 112 encodes a second set of syntax elements in the bitstream. The second set of syntax elements may specify a neural network (NN) post-filter process. The second set of syntax elements may be signaled in an SEI message (e.g., first SEI message 402). For example, first SEI message 402 is an NN post-filter characteristics SEI message.
3. Encoder 112 may determine at least a first region in the picture to which the NN post-filter process is to be applied.
4. Encoder 112 may determine at least a second region in the picture to which the NN post-filter process is not to be applied.
5. Encoder 112 may encode a third set of syntax elements in the bitstream. The third set of syntax element may comprise one or more syntax elements and may specify that the NN post-filter process is to be applied to the at least first determined region in the decoded picture and not to be applied to the at least second determined region in the decoded picture. The third set of syntax elements may be signaled in an SEI message (e.g., second SEI message 404). For example, second SEI message 404 is an NN post-filter activation SEI message.

In some embodiments, at least one of the first set of syntax elements and the second set of syntax elements are signaled in a parameter set such as a sequence parameter set (SPS), a picture parameter set (PPS), or an adaptive parameter set (APS), or in a header such as a picture header or a slice header. Alternatively or additionally, the second and/or third set of syntax elements may be carried in a systems layer such as being part of transport protocol data or file format data. This may include Moving Picture Experts Group (MPEG) systems protocols such as MPEG-Dynamic Adaptive Streaming over HTTP (DASH) or other ISO base media file-based protocols, and/or

Internet Engineering Task Force (IETF) transport protocols including Real-time Transport Protocol (RTP), Real-time Streaming Protocol (RTSP) and Secure Real-time Transport Protocol (SRTP), and session negotiation protocols as Session Description Protocol (SDP).

In some embodiments, the second set of syntax elements and the third set of syntax elements are signaled together (i.e., in the same SEI message) (meaning that first and second SEI messages 402 and 404 are the same message).

In some embodiments, the second set of syntax elements and the third set of syntax elements are the same set of syntax elements. However, in other embodiments, the second set of syntax elements and the third set of syntax elements are signaled in different locations. For example, the second set may be signaled in the SPS or file format while the third set may be signaled in a picture header or in a SEI message.

### Regions Defined Based on Rows and Columns

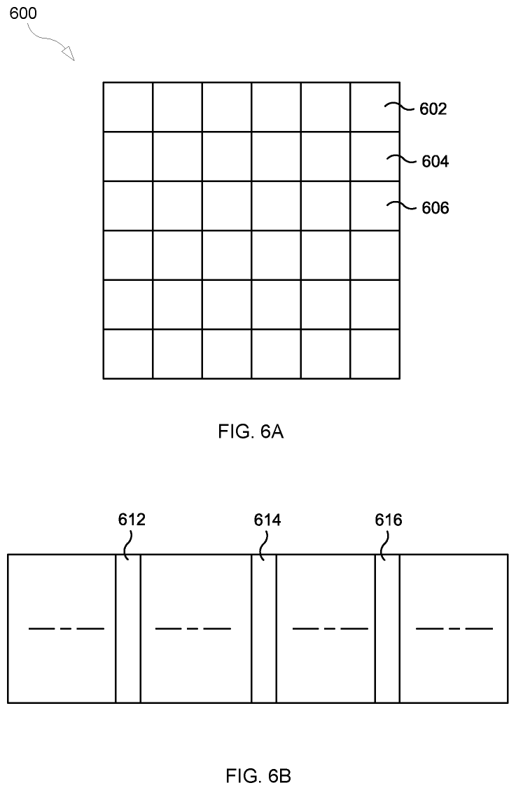

In some embodiments, as shown in FIG. 6A, a picture 600 may be divided into rows and columns where each cross-section of a row and a column defines a potential filtering region (e.g., 602, 604, 606, etc.)—a region where an NN-based filtering (NN post filtering) can be applied. The potential filtering regions (e.g., 602, 604, 606, etc.) may have the same size or may have different sizes. Even in case the potential filtering regions have the same size, one or more region(s) in the rightmost column and bottom row may be cropped to a smaller size if the picture width/height is not evenly divisible by the width/height of the potential filtering region.

The bitstream may indicate whether each of the potential filtering regions is an active region to which an NN-based filtering is to be applied or a non-active region to which no NN-based filtering is to be applied. For example, as shown in FIG. 6B, the bitstream may include a first field 612 indicating that region 602 is an active region, a second field 614 indicating that region 604 is a non-active region, and a third field 616 indicating that region 606 is an active region.

The bitstream may also indicate that whether an NN based filtering is to be applied to a region or to a whole picture. For example, there may be provided a set of one or more syntax elements indicating whether the NN-based filtering is to be applied to the whole picture or only to certain region(s). If the syntax element(s) indicate that the NN based filtering is to be applied to the whole picture, there is no need to signal the region-wise post-filter activation information (i.e., there is no need to signal the filtering area information indicating the filtering area to which the NN-based filtering is to be applied).

The potential filtering region may be defined by a region width, a region height, and a position in a partition of regions. The number of rows and columns may be explicitly signaled or be derived from the region width, the region height, the picture width, and the picture height. For example, the number of regions in a row and the number of regions in a column may be derived as follows:

$$num\_region \_rows = ⌈ picture\_width / region\_width ⌉$$

$$num\_region \_cols = ⌈ picture\_height / region\_height ⌉$$

where the ┌⋅┐ operator is for rounding up operation. For example, ┌1280/256┐=[5]=5 and ┌1280/512┐=┌2.5┐=3.

In some embodiments, the region width and the region height may be signaled in terms of luma samples (i.e., number of pixels). Alternatively, the region width and the region height may be signaled in terms of a specific unit, wherein the width of the specific unit is an integer factor of the region width, and the height of the specific unit is an integer factor of the region height. In other embodiments, the region width and the region height are signaled as a power of 2, (e.g., region_width=2^{c} where c is the signaled codeword resulting in possible region widths of 1, 2, 4, 8, 16, . . . , for c=0, 1, 2, 3, 4, . . . ,). In yet other embodiments, the region width is signaled as region_width=2^{c_minus_2+2}, where c_minus_2 is the signaled codeword resulting in possible region widths of 4, 8, 16, 32, . . . , for c_minus_2=0, 1, 2, 3, . . . . In an alternative embodiment, the region_width and region_height are both derived from a signaled syntax element region_size. As an example, region_width=region_size, region_height=region_size and region_size=2^{c_minus_2+2}. In another example, the region width is twice the size of the region height, such as region_width=2*region_size, region_height=region_size and region size=2^{c_minus_2+2}.

The number of regions in a row of a picture, the number of regions in a column of the picture, the region width, and/or the region height may be signaled with a u(n) descriptor, i.e., an unsigned integer using n bits, where n may be equal to 16.

In some embodiments, a default values of the region_width and region_height may be used (e.g., 16×16 or 32×32) by decoder 114 (meaning that decoder 114 already has this information), and thus the width and height of the region may not need to be signaled in the bitstream.

For each region, a syntax element (e.g., a flag) may specify whether the NN post-filter is to be applied for the region or not. In some embodiments, the set of flags for the regions are compressed, e.g., with run-length coding.

The syntax table with corresponding semantics below shows an example of the embodiment where the number of region rows and region columns are explicitly signaled. Additional text compared to JVET-AA2006v2 is marked in bold.

| | Descriptor |
|---|---|
| nn_post_filter_activation( payloadSize ) { | |
| nnpfa_id | ue(v) |
| nnpfa_{—}activate_{—}per_{—}region_{—}flag | u(1) |
| if (nnpfa_{—}activate_{—}per_{—}region) { | |
| nnpfa_{—}region_{—}width_{—}minus1 | u(n) |
| nnpfa_{—}region_{—}height_{—}minus1 | u(n) |
| nnpfa_{—}num_{—}region_{—}rows_{—}minus1 | u(n) |
| nnpfa_{—}num_{—}region_{—}cols_{—}minus1 | u(n) |
| for ( i=0; i < nnpfa_{—}num_{—}region_{—}rows_{—}minus1 + 1; | |
| i++ ){ | |
| for ( j=0; j < nnpfa_{—}num_{—}region_{—}cols_{—}minus1 | |
| + 1; j++ ) { | |
| nnpfa_{—}active_{—}region_{—}flag [ i ][ j | u(1) |
| ] | |
| } | |
| } | |
| } | |
| } | |

nnpfa_activate_per_region_flag equal to 1 specifies that the one or more NN post-processing filter characteristics SEI messages with nnpfc_id equal to nnfpa_id is activated per region defined by nnpfa_active_region_flag [i][j]. nnpfa_activate_per_region_flag equal to 0 specify that the one or more neural-network post-processing filter characteristics SEI messages apply for the whole picture.

nnpfa_region_width_minus1 plus 1 specifies the width of a region in terms of luma samples.

nnpfa_region_height_minus1 plus 1 specifies the height of a region in terms of luma samples.

nnpfa_num_region_rows_minus1 plus 1 specifies the number of region rows in the current picture.

nnpfa_num_region_cols_minus1 plus 1 specifies the number of region columns in the current picture.

nnpfa_active_region_flag [i][j] equal to 1 specifies that the one or more neural-network post-processing filter characteristics SEI messages with nnpfc_id equal to nnfpa_id is to be applied for the region at position (i*(nnpfa_region_width_minus1+1), j*(nnpfa_region_height_minus1+1)). nnpfa_active_region_flag [i][j] equal to 0 specifies that the one or more neural-network post-processing filter characteristics SEI messages with nnpfc_id equal to nnfpa_id is not to be applied for that region.

### Directly Identifying a Filtering Region

In some embodiments, instead of signalling, for each potential filtering region, an indication indicating whether an NN-based filtering is to be applied to the potential filtering region (e.g., as shown in FIG. 6B), the bitstream may directly identify filtering regions to which an NN-based filtering is to be applied.

The filtering regions identified by the bitstream may have the same size or may have different sizes. Also, the filtering regions may have the same shape or different shapes. As explained above, each of these filtering regions may be identified by its width, height, and a position of at least one of corners of the filtering region. As further explained above, the region width, the region height, and/or a position of at least one of corners of the filtering region may be signaled in terms of luma samples, units that are an integer scale factor of the region, or as a power of 2, and may be signaled with a u(n) descriptor, i.e., an unsigned integer using n bits, where n may be 16.

Additionally, the bitstream may include a first group of one or more syntax elements and a second group of one or more syntax elements. The first group of syntax elements may indicate whether to apply a per-region filtering (i.e., applying an NN-based filtering to a whole picture) or a per-picture filtering (i.e., applying an NN-based filtering only to certain region(s)), and the second group of syntax elements may specify the number of filtering regions to which an NN-based filtering is to be applied.

The first group of syntax elements and the second group of syntax elements may be the same. In such case, the first/second group of syntax elements indicating the value 0 may specify that an NN-based filtering is to be applied to a whole picture while the non-zero value of the first/second group of syntax element may specify the number of filtering regions to which an NN-based filtering is to be applied.

The syntax table with corresponding semantics below shows an example of the above embodiments. Additional syntax text compared to JVET-AA2006v2 is marked in bold.

| | Descriptor |
|---|---|
| nn_post_filter_activation ( payloadSize ) { | |
| nnpfa_id | ue(v) |
| nnpfa_{—}num_{—}active_{—}regions | ue(v) |
| for (i = 0; i < nnpfa_{—}num_{—}active_{—}regions; i++ ) | |
| nnpfa_{—}region_{—}width_{—}minus1[ i ] | u(v) |
| nnpfa_{—}region_{—}height_{—}minus1[ i ] | u(v) |
| nnpfa_{—}region_{—}top[ i ] | u(v) |
| nnpfa_{—}region_{—}left[ i ] | u(v) |
| } | |
| } | |

nnpfa_num_active_regions equal to 0 specifies that the neural-network post-processing filter specified by one or more NN post-processing filter characteristics SEI messages with nnpfc_id equal to nnfpa_id is activated for the whole current picture. nnpfa_num_active_regions larger than 0 specifies the number of non-overlapping regions in the current picture for which the neural-network post-processing filter specified by one or more NN post-processing filter characteristics SEI messages with nnpfc_id equal to nnfpa_id is activated. The value of nnpfa_num_active_regions shall be in the range of 0 to PicWidthInLumaSamples. PicHeightInLumaSamples.

nnpfa_region_width_minus1[i] plus 1 specifies the width of the i-th region in terms of luma samples. The length of the nnpfa_region_width_minus1[i] syntax element is Ceil (Log 2(PicWidthInLumaSamples).

nnpfa_region_height_minus1[i] plus 1 specifies the height of the i-th region in terms of luma samples. The length of the nnpfa_region_height_minus1[i] syntax element is Ceil (Log 2(PicHeightInLumaSamples).

nnpfa_region_top[i] specifies the vertical top position of the i-th region in terms of luma samples. The length of the nnpfa_region_top[i] syntax element is Ceil (Log 2(PicHeightInLumaSamples).

nnpfa_region_left[i] specifies the horizontal left position of the i-th region in terms of luma samples. The length of the nnpfa_region_left[i] syntax element is Ceil (Log 2(PicWidthInLumaSamples).

In some embodiments, in addition to identifying filtering regions to which an NN-based filtering is to be applied, the bitstream may indicate (using one or more syntax elements) whether an NN-based filtering is to be applied to the identified filtering regions or not (e.g., using a nnpfa_active_region_flag [i]).

The filtering regions identified by the bitstream may overlap in some embodiments, but may not overlap in other embodiments. In case the filtering regions overlap and the value of the nnpfa_active_region_flag [i] differs, a rule could be applied that the last signaled region determines the active state of the overlapping regions. This may, for instance, allow having a region to which no NN-based filtering is applied inside another region to which an NN-based filtering is applied.

In some embodiments, the signaling of the region width, the region height, and/or the vertical and horizontal positions of a region may utilize redundancies between the sizes and positions of the regions. First, if it is known that all regions have the same size, this could be specified with a signaled syntax element and the region size then only needs to be signaled once. Alternatively, if regions of a picture are often the same size, but not always, the region width and height could be copied or predicted from the previous signaled region. Second, the vertical and horizontal positions of the regions could also be derived if certain requirements are met, such as regions for the full picture is signaled without overlap, and the regions are signaled in raster scan order. Third, if the region width, the region height, and/or the vertical and horizontal positions of the regions are devisable by a certain sub-unit, a scale factor could be signaled first that is multiplied by the signaled width, height and/or vertical and horizontal positions of the regions.

The syntax table with corresponding semantics below shows an example of utilizing redundancies for the sizes and positions for this embodiment. Additional syntax text compared to JVET-AA2006v2 is marked in bold.

| | Descriptor |
|---|---|
| nn_post_filter_activation ( payloadSize ) { | |
| nnpfa_id | ue(v) |
| nnpfa_{—}num_{—}regions | ue(v) |
| if (nnpfa_{—}num_{—}regions > 0) { | |
| nnpfa_{—}all_{—}regions_{—}equal_{—}size_{—}flag | u(1) |
| nnpfa_{—}regions_{—}in_{—}raster_{—}scan_{—}order_{—}flag | u(1) |
| nnpfa_{—}scale_{—}factor_{—}minus1 | ue(v) |
| } | |
| for (i = 0; i < nnpfa_{—}num_{—}regions; i++) | |
| if ( i == 0 \|\| !nnpfa_{—}all_{—}regions_{—}equal_{—}size_{—}flag ) { | |
| nnpfa_{—}region_{—}width_{—}minus1[ i ] | u(v) |
| nnpfa_{—}region_{—}height_{—}minus1[ i ] | u(v) |
| } | |
| if ( !nnpfa_{—}regions_{—}in_{—}raster_{—}scan_{—}order_{—}flag ) { | |
| nnpfa_{—}region_{—}top[ i ] | u(v) |
| nnpfa_{—}region_{—}left[ i ] | u(v) |
| } else | |
| nnpfa_{—}active_{—}region_{—}flag [ i ] | u(1) |
| } | |
| } | |

nnpfa_num_regions equal to 0 specifies that the neural-network post-processing filter specified by the one or more neural-network post-processing filter characteristics SEI messages with nnpfc_id equal to nnfpa_id is activated for the whole current picture. nnpfa_num_regions larger than 0 specifies the number of non-overlapping regions in the current picture for which the neural-network post-processing filter specified by one or more neural-network post-processing filter characteristics SEI messages with nnpfc_id equal to nnfpa_id is activated. The value of nnpfa_num_regions shall be in the range of 0 to PicWidthInLumaSamples ⋅ PicHeightInLumaSamples.

nnpfa_all_regions_equal_size_flag equal to 1 specifies that all regions have the same width and height. nnpfa_all_regions_equal_size_flag equal to 0 specifies that all regions may not have the same width and height.

nnpfa_regions_in_raster_scan_order_flag equal to 1 specifies that regions are in raster scan order and cover the whole picture. nnpfa_regions_in_raster_scan_order_flag equal to 0 specifies that regions may not be in raster scan order and cover the whole picture.

nnpfa_scale_factor_minus1 plus 1 specifies the scale factor to multiply with to derive the width, height, vertical and horizontal positions for the regions. The value of nnpfa_scale_factor_minus1 shall be in the range of 0 to max (PicWidthInLumaSamples, PicHeightInLumaSamples).

nnpfa_scaled_region_width_minus1[i] plus 1 multiplied by (nnpfa_scale_factor_minus1+1) specifies the width of the i-th region in terms of luma samples. The length of the nnpfa_scaled_region_width_minus1[i] syntax element is Ceil (Log 2(PicWidthInLumaSamples/(nnpfa_scale_factor_minus1+1)). If not present for a region i, the width of the i-th region is set to the width of the 0-th region.

nnpfa_scaled_region_height_minus1[i] plus 1 multiplied by (nnpfa_scale_factor_minus1+1) specifies the height of the i-th region in terms of luma samples. The length of the nnpfa_scaled_region_width_minus1[i] syntax element is Ceil (Log 2(PicHeightInLumaSamples/(nnpfa_scale_factor_minus1+1)). If not present for a region i, the height of the i-th region is set to the height of the 0-th region.

nnpfa_scaled_region_top[i] multiplied by (nnpfa_scale_factor_minus1+1) specifies the vertical top position of the i-th region in terms of luma samples. The length of the nnpfa_scaled_region_width_minus1[i] syntax element is Ceil (Log 2(PicHeightInLumaSamples/(nnpfa_scale_factor_minus1+1)). If not present for a region i, the vertical top position of the i-th region is set equal to the y-position of the first (x, y)-point in raster scan order of the picture not already occupied by a region.

nnpfa_scaled_region_left[i] multiplied by (nnpfa_scale_factor_minus1+1) specifies the horizontal left position of the i-th region in terms of luma samples. The length of the nnpfa_scaled_region_width_minus1[i] syntax element is Ceil (Log 2(PicWidthInLumaSamples/(nnpfa_scale_factor_minus1+1)). If not present for a region i, the horizontal left position of the i-th region is set equal to the x-position of the first (x, y)-point in raster scan order of the picture not already occupied by a region.

nnpfa_active_region_flag [i] equal to 1 specifies that the neural-network post-processing filter specified by one or more neural-network post-processing filter characteristics SEI messages with nnpfc_id equal to nnfpa_id is to be applied for the i-th region. nnpfa_active_region_flag [i] equal to 0 specifies that the neural-network post-processing filter specified by the one or more neural-network post-processing filter characteristics SEI messages with nnpfc_id equal to nnfpa_id is not to be applied for that region. If not present, nnpfa_active_region_flag [i] is inferred to be equal to 1.

In the semantics above PicWidthInLumaSamples and PicHeightInLumaSamples may be replaced by the actual picture width and height if it is known or a fixed number for the maximum allowed picture width and height.

Determining Size and Position of a Filtering Region from Existing Partition Structure

In some embodiments, filtering regions may correspond to an existing partition (e.g., a CU, CTU, slice, or tile). For example, there may be a 1-to-1 relationship between an NN patch and a filtering region such that each patch is one region.

The benefit with this embodiment is of course that the size and position of the regions are given by the syntax used for decoding the picture, and no additional syntax elements are needed to signal the size and position of the regions. The only extra thing that would need to be signaled is what type of structure to use (e.g., CTU, unless that is predefined) and whether to apply the NN post-filter for each of the regions or not.

A downside may be that since a post-filter is applied after decoding, the post-filtering entity may only have access to the parsed NN post-filter parameters and the decoded picture and not to other parameters from the bitstream such as the internal structures used.

In a version of this embodiment, the syntax supports either implicit signaling of the regions as above or explicit signaling of the regions as in embodiments 2 and 3. A syntax element could be signaled to indicate what type of region signaling is used, e.g., nnpfa_region_type, where a value of 0 could mean apply the NN post-filter to the whole picture (no regions), a value of 1 could mean use the region signaling of embodiment 3 and a value of 1 could mean use CTUs as regions.

### Application of Different NN-Based Filterings to One or More Regions

In some embodiments, the bitstream may indicate that multiple NN-based filterings (a.k.a., NN post-filtering) are to be applied for one or more regions of a decoded picture. More specifically, the bitstream may include two or more NN post-filter activation SEI messages where each NN post-filter activation SEI message references its own NN post-filter characteristics SEI message and specifies regions to which the corresponding NN post-filtering should be applied. Alternatively, an NN post-filter activation SEI message may reference more than one NN post-filter characteristics SEI messages. In such embodiment, for each filtering region specified in the NN activation SEI message, it may be specified as to which NN post-filter is to be applied.

The syntax table with corresponding semantics below shows an example of the content of the bitstream according to the above embodiments. Additional syntax text compared to JVET-AA2006v2 is marked in bold.

| | Descriptor |
|---|---|
| nn_post_filter_activation ( payloadSize ) { | |
| nnpfa_{—}num_{—}ids | ue(v) |
| for (j = 0; j < nnpfa_{—}num_{—}ids; j++) | |
| nnpfa_id [ j ] | ue(v) |
| nnpfa_{—}num_{—}active_{—}regions | ue(v) |
| for (i = 0; i < nnpfa_{—}num_{—}active_{—}regions; i++) { | |
| nnpfa_{—}region_{—}width_{—}minus1[ i ] | u(n) |
| nnpfa_{—}region_{—}height_{—}minus1[ i ] | u(n) |
| nnpfa_{—}region_{—}top[ i ] | u(n) |
| nnpfa_{—}region_{—}left[ i ] | u(n) |
| for (j = 0; j < nnpfa_{—}num_{—}ids; j++) | |
| nnpfa_{—}active_{—}region_{—}flag[ i ][ j ] | u(1) |
| } | |
| } | |
| } | |

nnpfa_num_ids specifies the number of NN post-processing filters specified by one or more NN post-processing filter characteristics SEI messages with a certain nnpfc_id that may be used for post-processing filtering for the current picture.

nnpfa_id [j] specifies that the NN post-processing filter specified by one or more neural-network post-processing filter characteristics SEI messages that pertain to the current picture and have nnpfc_id equal to nnfpa_id [j] may be used for post-processing filtering for the current picture.

nnpfa_active_region_flag [i][j] equal to 1 specifies that the one or more NN post-processing filter characteristics SEI messages with nnpfc_id equal to nnfpa_id [j] is to be applied for the i-th region. nnpfa_active_region_flag [i][j] equal to 0 specifies that the one or more NN post-processing filter characteristics SEI messages with nnpfc_id equal to nnfpa_id [j] is not to be applied for the i-th region.

In some embodiments, the picture may be divided into rows and columns where each cross-section of a row and a column defines a region, and for each region, more than one NN-based filter is to be applied.

In one example, for each region, one or more syntax elements may specify which NN-based filtering is to be applied to the region, if any. The syntax element(s) with the value 0 means that no NN-based filtering will be applied, a value of 1 means that a first NN-based filtering will be applied, a value of 2 means that a second NN-based filtering will be applied, etc. In some embodiments, a set of syntax elements for the regions may be compressed, e.g., with run-length coding.

The syntax table with corresponding semantics below shows an example of the content of the bitstream according to the above embodiments where the number of region rows and columns are explicitly signaled. Additional syntax text compared to JVET-AA2006v2 is marked in bold.

| | Descriptor |
|---|---|
| nn_post_filter_activation( payloadSize ) { | |
| num_{—}npfa_{—}ids_{—}minus1 | ue(v) |
| for ( i=1; i < num_{—}npfa_{—}ids_{—}minus1 + 1; i++ ) { | |
| nnpfa_{—}id [ i ] | ue(v) |
| nnpfa_{—}activate_{—}per_{—}region_{—}flag | u(1) |
| if (nnpfa_{—}activate_{—}per_{—}region) { | |
| nnpfa_{—}region_{—}width_{—}minus1 | u(n) |
| nnpfa_{—}region_{—}height_{—}minus1 | u(n) |
| nnpfa_{—}num_{—}region_{—}rows_{—}minus1 | u(n) |
| nnpfa_{—}num_{—}region_{—}cols_{—}minus1 | u(n) |
| for ( i=0; i < nnpfa_{—}num_{—}region_{—}rows_{—}minus1 + 1; | |
| i++ ) { | |
| for (j=0; j < nnpfa_{—}num_{—}region_{—}cols_{—}minus1 | |
| + 1; j++ ) { | |
| nnpfa_{—}which_{—}NN [ i ][ j ] | u(v) |
| } | |
| } | |
| } | |
| } | |

num_npfa_ids_minus1 plus 1 specifies the number of filters used.

nnpfa_id [i] specifies that the NN post-processing filter specified by one or more NN post-processing filter characteristics SEI messages that pertain to the current picture and have nnpfc_id equal to nnfpa_id [i] may be used for post-processing filtering for the current picture.

nnpfa_activate_per_region_flag equal to 1 specifies that the one or more NN post-processing filter characteristics SEI messages with nnpfc_id equal to nnfpa_id is activated per region defined by nnpfa_active_region_flag [i][j]. nnpfa_activate_per_region_flag equal to 0 specify that the one or more neural-network post-processing filter characteristics SEI messages apply for the whole picture.

nnpfa_region_width_minus1 plus 1 specifies the width of a region in terms of luma samples.

nnpfa_region_height_minus1 plus 1 specifies the height of a region in terms of luma samples.

nnpfa_num_region_rows_minus1 plus 1 specifies the number of region rows in the current picture.

nnpfa_num_region_cols_minus1 plus 1 specifies the number of region columns in the current picture.

nnpfa_which_NN [i][j] larger than 0 specifies that the one or more NN post-processing filter characteristics SEI messages with nnpfc_id equal to nnfpa_id [nnpfa_which_NN [i][j]−1] is to be applied for the region at position (i*(nnpfa_region_width_minus1+1), j*(nnpfa_region_height_minus1+1)). nnpfa_which_NN [i][j] equal to 0 specifies that no NN post-processing filter is to be applied for that region. The value of nnpfa_which_NN [i][j] is in the range of 0 to num_npfa_ids_minus1+1. The length of the nnpfa_which_NN [i][j] syntax element is Ceil (Log 2(num_npfa_ids_minus1+2).

### Compound SEI Message (e.g., Scalable Nesting SEI Message)

In some embodiments, the bitstream may include a compound SEI message comprising multiple SEI messages, and each of the multiple SEI messages may be associated with a region of a decoded picture. For example, the compound SEI message may comprise a first SEI message associated with a first region of the decoded picture and a second SEI message associated with a second region of the decoded picture.

The first SEI message may indicate that an NN-based filtering is to be applied to the first region of the decoded picture and the second SEI message may indicate that an NN-based filtering is to be applied to the second region of the decoded picture. The first and second regions may or may not align with subpicture borders, and may be signaled using any one of the methods described with respect to the embodiments above.

In the embodiments where the compound SEI message is used, decoder 114 may perform all or a subset of the following steps:
1) Decoder 114 receives a bitstream
2) Decoder 114 decodes a coded picture from the bitstream.
3) Decoder 114 decodes a compound SEI message from the bitstream.
4) Decoder 114 determines that region-based processing of the compound SEI message should be used. This may be determined by decoding one or more syntax elements from the compound SEI message.
5) Decoder 114 determines spatial locations of at least first and second regions of a picture. This may be performed according to any of the previously described methods or by deriving the top-left positions of the regions and the heights and widths of the at least two regions.
6) Decoder 114 decodes at least one first SEI message for the first region and one second SEI message for the second region from syntax elements in the compound SEI message.
7) Decoder 114 applies the first SEI message to the part of the decoded picture that is within the first region of the picture.
8) Decoder 114 applies the second SEI message to the part of the decoded picture that is within the second region of the picture. Each of the first region and the second region does not align exactly with a subpicture border.

In the embodiments where the compound SEI message is used, encoder 112 may perform all or a subset of the following steps:
1) Encoder 112 encodes a picture into a coded picture
2) Encoder 112 determines a first SEI message to be applied to a first region of a decoded picture
3) Encoder 112 determines a second SEI message to be applied to a second region of a decoded picture. Each of the first region and the second region does not align exactly with a subpicture border.
4) Encoder 112 encodes the first SEI message and the second SEI message into a compound SEI message.
5) Encoder 112 encodes information indicating that (i) region-based processing of the compound SEI message should be used and (ii) that the first SEI message is to be applied to the part of the decoded picture that is within the first region of the picture and that the second SEI message is to be applied to the part of the decoded picture that is within the second region. This information may be coded into the compound SEI message.
6) Encoder 112 sends the coded picture and the compound SEI message in a bitstream.

In the example syntax and semantics below, the scalable nesting SEI message (i.e., the compound message) is extended with the signaling of spatial information of the region. Additional text compared to VVC v2 is marked in bold. In this example, the sn_region_flag is conditioned on the sn_subpic_flag. In another example, this is not conditioned, (for example, in one version subpicture signaling may be replaced by region signaling).

| | Descriptor |
|---|---|
| scalable_nesting( payloadSize ) { | |
| sn_ols_flag | u(1) |
| sn_subpic_flag | u(1) |
| if( sn_ols_flag ) { | |
| sn_num_olss_minus1 | ue(v) |
| for( i = 0; i <= sn_num_olss_minus1; i++ ) | |
| sn_ols_idx_delta_minus1[ i ] | ue(v) |
| } else { | |
| sn_all_layers_flag | u(1) |
| if( !sn_all_layers_flag ) { | |
| sn_num_layers_minus1 | ue(v) |
| for( i = 1; i <= sn_num_layers_minus1; i++ ) | |
| sn_layer_id[ i ] | u(6) |
| } | |
| } | |
| if( sn_subpic_flag ) { | |
| sn_num_subpics_minus1 | ue(v) |
| sn_subpic_id_len_minus1 | ue(v) |
| for( i = 0; i <= sn_num_subpics_minus1; i++ ) | |
| sn_subpic_id[ i ] | u(v) |
| } else { | |
| sn_{—}region_{—}flag | u(1) |
| if ( sn_{—}region_{—}flag ) { | |
| sn_{—}num_{—}regions_{—}minus1 | ue(v) |
| for ( i = 0; i <= sn_{—}num_{—}regions_{—}minus1; i++ ) { | |
| sn_{—}region_{—}width_{—}minus1[ i ] | u(n) |
| sn_{—}region_{—}height_{—}minus1[ i ] | u(n) |
| sn_{—}region_{—}top[ i ] | u(n) |
| sn_{—}region_{—}left[ i ] | u(n) |
| } | |
| } | |
| sn_num_seis_minus1 | ue(v) |
| while( !byte_aligned( ) ) | |
| sn_zero_bit /* equal to 0 */ | u(1) |
| for( i = 0; i <= sn_num_seis_minus1; i++ ) | |
| sei_message( ) | |
| } | |

sn_region_flag specifies that the scalable-nested SEI messages that apply to specified output layer sets (OLSs) or layers apply only to specific regions of the specified OLSs or layers. sn_num_regions equal to 0 specifies that the scalable-nested SEI messages that apply to specific OLSs or layers apply to the full picture of the specified OLSs or layers.

sn_num_regions_minus1 plus 1 specifies the number of regions in each picture to which the scalable nested SEI messages apply.

sn_region_width_minus1[i] plus 1 specifies the width of the i-th region in terms of luma samples.

sn_region_height_minus1[i] plus 1 specifies the height of the i-th region in terms of luma samples.

sn_region_top[i] specifies the vertical top position of the i-th region in terms of luma samples.

sn_region_left[i] specifies the horizontal left position of the i-th region in terms of luma samples.

The methods performed by decoder 114 according to the above described embodiments can be summarized as follows:

General method

| | |
|---|---|
| 1. | A method for decoding a coded picture from a bitstream and applying a first NN post- |
| | filter process, the method comprising |
| | Decoding a coded picture from a first set of syntax elements in the bitstream to |
| | produce a decoded picture |
| | Decoding a second set of syntax elements from the bitstream, wherein the second set |
| | of syntax elements specifies a first neural network (NN) post-filter process |
| | Decoding a third set of syntax elements, comprising one or more syntax elements, |
| | from the bitstream |
| | Determining from the one or more syntax elements in the third set of syntax elements |
| | that the first NN post-filter process is to be applied for at least a first region in the |
| | decoded picture and not to be applied for at least a second region in the decoded |
| | picture, wherein at least the first region does not correspond to a subpicture. |
| | Applying the first NN post-filter process to the at least first region in the decoded |
| | picture without applying it to the at least second region in the decoded picture. |
| 2. | The method of claim 1, wherein at least one of the second set of syntax elements and the |
| | third set of syntax elements is signaled in one or more SEI messages |
| 3. | The method of claim 2, wherein the second set of syntax elements is signaled in an NN |
| | post-filter characteristics SEI message and/or the third set of syntax elements is signaled |
| | in an NN post-filter activation SEI message |
| 4. | The method of claim 1, wherein at least one of the second set of syntax elements and the |
| | third set of syntax elements are signaled in one or more parameter set such as the SPS, |
| | PPS or APS, or in a header such as the picture header or slice header or in a systems |
| | layer such as being part of transport protocol data or file format data. |
| 5. | The method of any of the previous claims wherein the borders of the first and second |
| | regions are aligned with borders of patches in the NN post-filter. |
| 6. | The method of any of claims 1-4 wherein at least one border of the first and second |
| | regions are not aligned with borders of patches in the NN post-filter. |

Regions based on rows and columns or region width and height

| | |
|---|---|
| 7. | The method of any of the previous claims wherein the third set of syntax elements |
| | comprises one or more syntax elements used to derive at least one of a size and a position |
| | for at least one of the first and second region. |
| 8. | The method of claim 7 wherein the one or more syntax elements of the third set of syntax |
| | elements comprises at least one of a region width, a region height, number of region |
| | rows, number of region columns, a region vertical position, region horizontal position, |
| | and region identifier. |
| 9. | The method of any of the previous claims wherein decoding the third set of syntax |
| | elements comprises determining the size and position for two or more regions. |
| 10. | The method of claim 9 wherein the tow or more regions cover the whole picture and |
| | none of the regions overlap. |
| 11. | The method of any of the previous claims wherein the third set of syntax elements further |
| | comprises one or more syntax elements for each region specifying whether the first NN |
| | loop-filter process is to be applied for that region or not. |
| 12. | The method of any of the previous claims wherein for at least one of the first and second |
| | region at least one of a region width, a region height, number of region rows, number of |
| | region columns, a region vertical position, a region horizontal position and a region |
| | identifier are derived. |

Determine region size and position from existing partition structures

| | |
|---|---|
| 13. | The method of any of the previous claims, wherein a region is at least one of a CU, CTU, |
| | slice, tile or a patch size of an NN postfilter. |

Use multiple NN post-filters for different regions.

| | |
|---|---|
| 14. | The method of any of the previous claims, further comprising: |
| | Decoding a fourth set of syntax elements, wherein the fourth set of syntax elements |
| | specifies a second NN post-filter process different from the first NN post-filter |
| | process |
| | Determining from the one or more syntax elements in the third set of syntax elements |
| | that the second NN post-filter process is to be applied for the at least second region |
| | in the decoded picture |
| | Applying the second NN post-filter process to the at least second region in the |
| | decoded picture |
| 15. | The method of claim 14, wherein the third set of syntax elements further comprises one |
| | or more syntax elements specifying that the second NN post-filter process is to be |
| | applied for at least the second region in the decoded picture. |
| 16. | The method of any previous claim, wherein the first and second region does not cover |
| | the entire picture. |
| 17. | The method of any of the previous claims further comprising, deriving from the third set |
| | of syntax elements that for a third region of the picture, no NN post-filter is to be applied. |
| 18. | The method of any of the previous claims wherein at least one NN post-filter process is |
| | used for at least one of the following purposes: visual quality improvement, super- |
| | resolution, picture upsampling, and chroma format upsampling. |

Signal regions in the scalable nesting SEI message

| | |
|---|---|
| 19. | The method of any of the previous claims wherein at least one of the second set of syntax |
| | elements and the third set of syntax elements is signaled in a scalable nesting SEI |
| | message. |

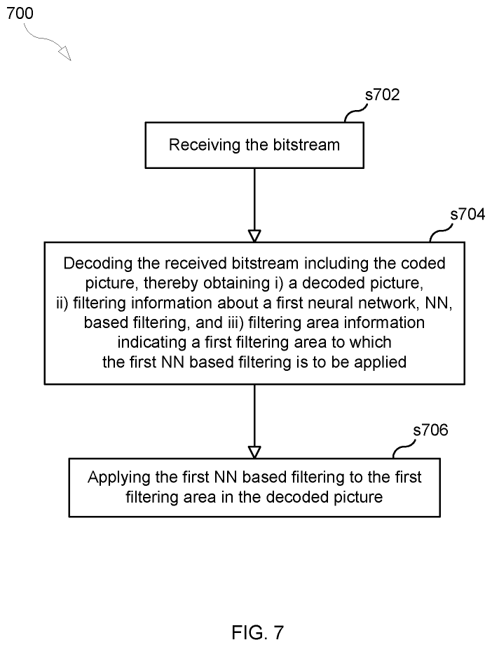

FIG. 7 shows a process 700 for processing a bitstream including a coded picture, according to some embodiments. Process 700 may begin with step s702. Step s702 comprises receiving the bitstream. Step s704 comprises decoding the received bitstream including the coded picture, thereby obtaining i) a decoded picture, ii) filtering information about a first neural network, NN, based filtering, and iii) filtering area information indicating a first filtering area to which the first NN based filtering is to be applied. Step s706 comprises applying the first NN based filtering to the first filtering area in the decoded picture. The received bitstream includes a group of one or more syntax elements, the group of one or more syntax elements indicates that the first NN based filtering is to be applied to a first part of the decoded picture but is not to be applied to a second part of the decoded picture, and the first filtering area corresponds to the first part of the decoded picture.

In some embodiments, the size of the first filtering area is different from the size of the decoded picture and the size of any subpicture included in the coded picture in the bitstream.

In some embodiments, the received bitstream comprises a first set of syntax elements, a second set of syntax elements, and a third set of syntax elements, and decoding the received bitstream comprises: decoding the first set of syntax elements, thereby obtaining the decoded picture; decoding the second set of syntax elements, thereby obtaining the filtering information; and decoding the third set of syntax elements, thereby obtaining the first filtering area information.

In some embodiments, the received bitstream comprises a first supplemental enhancement information, SEI, message and a second SEI message, the second set of syntax elements is included in the first SEI message, and the third set of syntax elements is included in the second SEI message.

In some embodiments, the first SEI message is an NN post-filter characteristics SEI message and, the second SEI message is an NN post-filter activation SEI message.

In some embodiments, the third set of syntax elements comprises the one or more syntax elements.

In some embodiments, the received bitstream comprises a supplemental enhancement information, SEI, message, and both the second set of syntax elements and the third set of syntax elements are included in the SEI message.

In some embodiments, at least one of the second set of syntax elements and the third set of syntax elements is included in i) one or more parameter sets, ii) a header, iii) or a system layer, said one or more parameter sets includes one or more of: a sequence parameter set, SPS, a picture parameter set, PPS, or an adaptive parameter set, APS, the header is a picture header or a slice header, and the system layer is a part of transport protocol data or file format data.

In some embodiments, the first NN based filtering is configured to be performed on a patch basis, and borders of a patch align with borders of the first filtering area.

In some embodiments, the first NN based filtering is configured to be performed on a patch basis, and borders of a patch do not align with borders of the first filtering area.

In some embodiments, the first filtering area information indicates one or more of: a width of the first filtering area, a height of the first filtering area, a number of rows of filtering areas in a decoded picture, a number of columns of filtering areas in a decoded picture, a position of at least one of the corners of the first filtering area, or a filtering area identifier identifying the first filtering area.

In some embodiments, the received bitstream identifies a plurality of picture areas within a picture, and the received bitstream indicates, for each of the plurality of picture areas, whether an NN based filtering is to be applied to the picture area.

In some embodiments, the received bitstream includes a group of one or more syntax elements, and the group of one or more syntax elements indicates whether the first NN based filtering is to be applied to the whole decoded picture.

In some embodiments, the group of one or more syntax elements indicates an integer, and the integer indicates a number of picture areas within a picture, to which an NN based filtering is to be applied, or a number of picture areas within a picture, to which an NN based filtering is not to be applied.

In some embodiments, the first filtering area is one of: a coding unit, CU, a coding tree unit, CTU, a slice, a tile or a patch for the NN-based filtering.

In some embodiments, process 400 comprises obtaining another filtering information about a second NN based filtering, wherein the second NN based filtering is different from the first NN based filtering, and further wherein the filtering area information indicates a second filtering area to which the second NN based filtering is to be applied; and applying the second NN based filtering to the second filtering area.

In some embodiments, the filtering area information indicates that no NN-based filtering is to be applied to an area that is different from the first filtering area and the second filtering area.

In some embodiments, the first NN based filtering is used for one or more of: visual quality improvement, providing a super-resolution, picture upsampling, and chroma format upsampling.

In some embodiments, at least one of the second set of syntax elements and the third set of syntax elements is signaled in a compound SEI message (e.g., a scalable nesting SEI message).

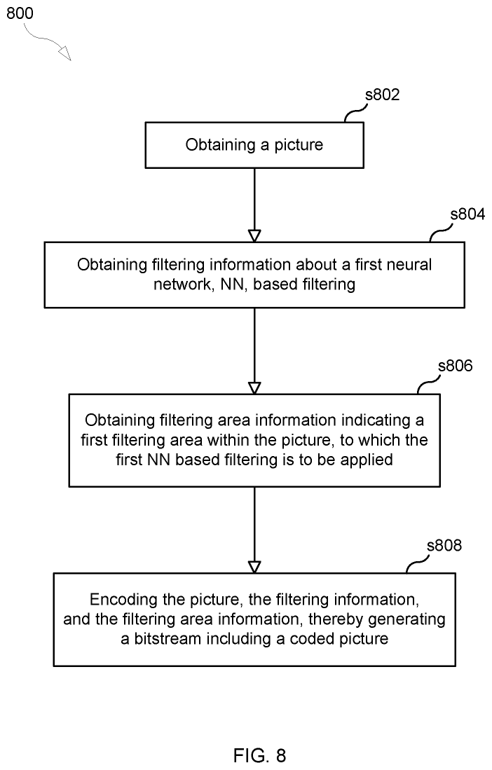

FIG. 8 shows a process 800 performed by an encoder, according to some embodiments. Process 800 may begin with step s802. Step s802 comprises obtaining a picture. Step s804 comprises obtaining filtering information about a first neural network, NN, based filtering. Step s806 comprises obtaining filtering area information indicating a first filtering area within the picture, to which the first NN based filtering is to be applied. Step s808 comprises encoding the picture, the filtering information, and the filtering area information, thereby generating a bitstream including a coded picture.

In some embodiments, process 800 comprises one or more of: storing the bitstream in a storage medium of the encoder; transmitting the bitstream towards a storage entity for storing the bitstream; or transmitting towards a decoder the bitstream.

In some embodiments, the bitstream includes a group of one or more syntax elements, the group of one or more syntax elements indicates that the first NN based filtering is to be applied to a first part of a decoded picture but is not to be applied to a second part of the decoded picture, and the first filtering area corresponds to the first part of the decoded picture.

In some embodiments, the size of the first filtering area is different from the size of a decoded picture and the size of any subpicture included in the coded picture in the bitstream.

In some embodiments, the bitstream comprises a first set of syntax elements, a second set of syntax elements, and a third set of syntax elements, the first set of syntax elements corresponds to the coded picture, the second set of syntax elements corresponds to the filtering information, and the third set of syntax elements corresponds to the first filtering area information.

In some embodiments, the bitstream comprises a first supplemental enhancement information, SEI, message and a second SEI message, the second set of syntax elements is included in the first SEI message, and the third set of syntax elements is included in the second SEI message.

In some embodiments, the first SEI message is an NN post-filter characteristics SEI message and, the second SEI message is an NN post-filter activation SEI message.

In some embodiments, the third set of syntax elements comprises the one or more syntax elements.

In some embodiments, the bitstream comprises a supplemental enhancement information, SEI, message, and both the second set of syntax elements and the third set of syntax elements are included in the SEI message.

In some embodiments, at least one of the second set of syntax elements and the third set of syntax elements is included in i) one or more parameter sets, ii) a header, iii) or a system layer, said one or more parameter sets includes one or more of: a sequence parameter set, SPS, a picture parameter set, PPS, or an adaptive parameter set, APS, the header is a picture header or a slice header, and the system layer is a part of transport protocol data or file format data.

In some embodiments, the first NN based filtering is configured to be performed on a patch basis, and borders of a patch align with borders of the first filtering area.

In some embodiments, the first NN based filtering is configured to be performed on a patch basis, and borders of a patch do not align with borders of the first filtering area.

In some embodiments, the first filtering area information indicates one or more of: a width of the first filtering area, a height of the first filtering area, a number of rows of filtering areas in a decoded picture, a number of columns of filtering areas in a decoded picture, a position of at least one of the corners of the first filtering area, or a filtering area identifier identifying the first filtering area.

In some embodiments, the bitstream identifies a plurality of picture areas within a picture, and the bitstream indicates, for each of the plurality of picture areas, whether an NN based filtering is to be applied to the picture area.

In some embodiments, the bitstream includes a group of one or more syntax elements, and the group of one or more syntax elements indicates whether the first NN based filtering is to be applied to a whole decoded picture.

In some embodiments, the group of one or more syntax elements indicates an integer, and the integer indicates a number of picture areas within a picture, to which an NN based filtering is to be applied, or a number of picture areas within a picture, to which an NN based filtering is not to be applied.

In some embodiments, the first filtering area is one of: a coding unit, CU, a coding tree unit, CTU, a slice, a tile or a patch for the NN-based filtering.

In some embodiments, encoding the picture, the filtering information, and the filtering area information comprises encoding the picture, the filtering information, and the filtering area information, and another filtering information about a second NN based filtering, the second NN based filtering is different from the first NN based filtering, and the filtering area information indicates a second filtering area to which the second NN based filtering is to be applied.

In some embodiments, the filtering area information indicates that no NN-based filtering is to be applied to an area that is different from the first filtering area and the second filtering area.

In some embodiments, the first NN based filtering is used for one or more of: visual quality improvement, providing a super-resolution, picture upsampling, and chroma format upsampling.

In some embodiments, at least one of the second set of syntax elements and the third set of syntax elements is signaled in a compound SEI message (e.g., a scalable nesting SEI message).

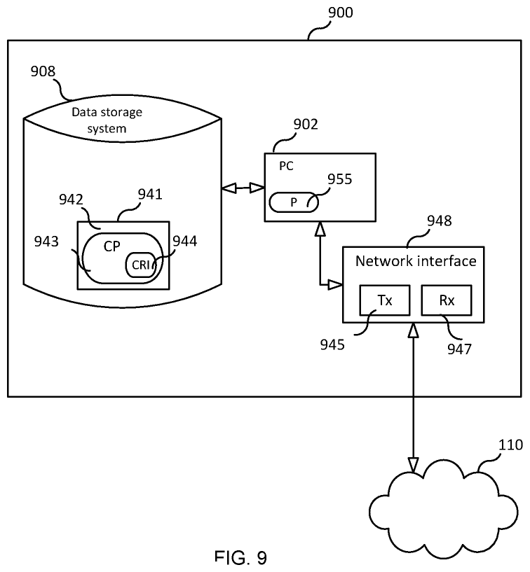

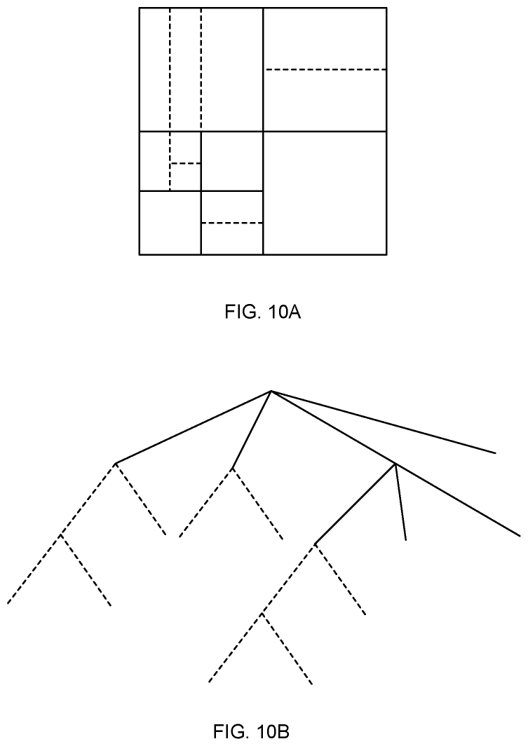

FIG. 9 is a block diagram of an apparatus 900 for implementing the encoder 112, the decoder 114, or a component included in the encoder 112 or the decoder 114 (e.g., the NN filter), according to some embodiments. When apparatus 900 implements a decoder, apparatus 900 may be referred to as a “decoding apparatus 900,” and when apparatus 900 implements an encoder, apparatus 900 may be referred to as an “encoding apparatus 900.” As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

### SUMMARY OF EMBODIMENTS

A1. A method (700) for processing a bitstream including a coded picture, the method comprising:
receiving (s702) the bitstream;
decoding (s704) the received bitstream including the coded picture, thereby obtaining i) a decoded picture, ii) filtering information about a first neural network, NN, based filtering, and iii) filtering area information indicating a first filtering area to which the first NN based filtering is to be applied; and
applying (s706) the first NN based filtering to the first filtering area in the decoded picture.

A2. The method of embodiment A1, wherein
the received bitstream includes a group of one or more syntax elements,
the group of one or more syntax elements indicates that the first NN based filtering is to be applied to a first part of the decoded picture but is not to be applied to a second part of the decoded picture, and
the first filtering area corresponds to the first part of the decoded picture.

A3. The method of embodiment A1 or A2, wherein the size of the first filtering area is different from the size of the decoded picture and the size of any subpicture included in the coded picture in the bitstream.

A4. The method of any one of embodiments A1-A3, wherein
the received bitstream comprises a first set of syntax elements, a second set of syntax elements, and a third set of syntax elements, and
decoding the received bitstream comprises:
   decoding the first set of syntax elements, thereby obtaining the decoded picture;
   decoding the second set of syntax elements, thereby obtaining the filtering information; and
   decoding the third set of syntax elements, thereby obtaining the first filtering area information.

A5. The method of embodiment A4, wherein
the received bitstream comprises a first supplemental enhancement information, SEI, message and a second SEI message,
the second set of syntax elements is included in the first SEI message, and
the third set of syntax elements is included in the second SEI message.

A6. The method of embodiment A5, wherein
the first SEI message is an NN post-filter characteristics SEI message and,
the second SEI message is an NN post-filter activation SEI message.

A6b. The method of any one of embodiments A4-A6, wherein the third set of syntax elements comprises the one or more syntax elements.

A7. The method of embodiment A4, wherein
the received bitstream comprises a supplemental enhancement information, SEI, message, and
both the second set of syntax elements and the third set of syntax elements are included in the SEI message.

A8. The method of embodiment A4, wherein
at least one of the second set of syntax elements and the third set of syntax elements is included in i) one or more parameter sets, ii) a header, iii) or a system layer,
said one or more parameter sets includes one or more of: a sequence parameter set, SPS, a picture parameter set, PPS, or an adaptive parameter set, APS,
the header is a picture header or a slice header, and
the system layer is a part of transport protocol data or file format data.

A9. The method of any one of embodiments A1-A8, wherein
the first NN based filtering is configured to be performed on a patch basis, and
borders of a patch align with borders of the first filtering area.

A10. The method of any one of embodiments A1-A8, wherein
the first NN based filtering is configured to be performed on a patch basis, and
borders of a patch do not align with borders of the first filtering area.

A11. The method of any one of embodiments A1-A10, wherein the first filtering area information indicates one or more of: a width of the first filtering area, a height of the first filtering area, a number of rows of filtering areas in a decoded picture, a number of columns of filtering areas in a decoded picture, a position of at least one of the corners of the first filtering area, or a filtering area identifier identifying the first filtering area.

A12. The method of any one of embodiments A1-A11, wherein
the received bitstream identifies a plurality of picture areas within a picture, and
the received bitstream indicates, for each of the plurality of picture areas, whether an NN based filtering is to be applied to the picture area.

A13. The method of any one of embodiments A1-A12, wherein
the received bitstream includes a group of one or more syntax elements, and
the group of one or more syntax elements indicates whether the first NN based filtering is to be applied to the whole decoded picture.

A14. The method of embodiment A13, wherein
the group of one or more syntax elements indicates an integer, and
the integer indicates a number of picture areas within a picture, to which an NN based filtering is to be applied, or a number of picture areas within a picture, to which an NN based filtering is not to be applied.

A15. The method of any one of embodiments A1-A14, wherein the first filtering area is one of: a coding unit, CU, a coding tree unit, CTU, a slice, a tile or a patch for the NN-based filtering.

A16. The method of any one of embodiments A1-A15, comprising:
obtaining another filtering information about a second NN based filtering, wherein the second NN based filtering is different from the first NN based filtering, and further wherein the filtering area information indicates a second filtering area to which the second NN based filtering is to be applied; and
applying the second NN based filtering to the second filtering area.

A17. The method of embodiment A16, wherein the filtering area information indicates that no NN-based filtering is to be applied to an area that is different from the first filtering area and the second filtering area.

A18. The method of any one of embodiments A1-A17, wherein the first NN based filtering is used for one or more of: visual quality improvement, providing a super-resolution, picture upsampling, and chroma format upsampling.

A19. The method of embodiment A4, wherein at least one of the second set of syntax elements and the third set of syntax elements is signaled in a compound SEI message (e.g., a scalable nesting SEI message).

B1. A method (800) performed by an encoder (900), the method comprising:
obtaining (s802) a picture;
obtaining (s804) filtering information about a first neural network, NN, based filtering;
obtaining (s806) filtering area information indicating a first filtering area within the picture, to which the first NN based filtering is to be applied; and
encoding (s808) the picture, the filtering information, and the filtering area information, thereby generating a bitstream including a coded picture.

B1a. The method of embodiment B1, comprising one or more of:
storing the bitstream in a storage medium of the encoder;
transmitting the bitstream towards a storage entity for storing the bitstream; or
transmitting towards a decoder the bitstream.

B2. The method of embodiment B1 or B1a, wherein
the bitstream includes a group of one or more syntax elements,
the group of one or more syntax elements indicates that the first NN based filtering is to be applied to a first part of a decoded picture but is not to be applied to a second part of the decoded picture, and
the first filtering area corresponds to the first part of the decoded picture.

B3. The method of any one of embodiments B1-B2, wherein the size of the first filtering area is different from the size of a decoded picture and the size of any subpicture included in the coded picture in the bitstream.

B4. The method of any one of embodiments B1-B3, wherein
the bitstream comprises a first set of syntax elements, a second set of syntax elements, and a third set of syntax elements,
the first set of syntax elements corresponds to the coded picture,
the second set of syntax elements corresponds to the filtering information, and
the third set of syntax elements corresponds to the first filtering area information.

B5. The method of embodiment B4, wherein
the bitstream comprises a first supplemental enhancement information, SEI, message and a second SEI message,
the second set of syntax elements is included in the first SEI message, and
the third set of syntax elements is included in the second SEI message.

B6. The method of embodiment B5, wherein
the first SEI message is an NN post-filter characteristics SEI message and,
the second SEI message is an NN post-filter activation SEI message.

B6b. The method of any one of embodiments B4-B6, wherein the third set of syntax elements comprises the one or more syntax elements.

B7. The method of embodiment B4, wherein
the bitstream comprises a supplemental enhancement information, SEI, message, and
both the second set of syntax elements and the third set of syntax elements are included in the SEI message.

B8. The method of embodiment B4, wherein
at least one of the second set of syntax elements and the third set of syntax elements is included in i) one or more parameter sets, ii) a header, iii) or a system layer,
said one or more parameter sets includes one or more of: a sequence parameter set, SPS, a picture parameter set, PPS, or an adaptive parameter set, APS,
the header is a picture header or a slice header, and
the system layer is a part of transport protocol data or file format data.

B9. The method of any one of embodiments B1-B8, wherein
the first NN based filtering is configured to be performed on a patch basis, and
borders of a patch align with borders of the first filtering area.

B10. The method of any one of embodiments B1-B8, wherein
the first NN based filtering is configured to be performed on a patch basis, and
borders of a patch do not align with borders of the first filtering area.

B11. The method of any one of embodiments B1-B10, wherein the first filtering area information indicates one or more of: a width of the first filtering area, a height of the first filtering area, a number of rows of filtering areas in a decoded picture, a number of columns of filtering areas in a decoded picture, a position of at least one of the corners of the first filtering area, or a filtering area identifier identifying the first filtering area.

B12. The method of any one of embodiments B1-B11, wherein
the bitstream identifies a plurality of picture areas within a picture, and
the bitstream indicates, for each of the plurality of picture areas, whether an NN based filtering is to be applied to the picture area.

B13. The method of any one of embodiments B1-B12, wherein
the bitstream includes a group of one or more syntax elements, and
the group of one or more syntax elements indicates whether the first NN based filtering is to be applied to a whole decoded picture.

B14. The method of embodiment B13, wherein
the group of one or more syntax elements indicates an integer, and
the integer indicates a number of picture areas within a picture, to which an NN based filtering is to be applied, or a number of picture areas within a picture, to which an NN based filtering is not to be applied.

B15. The method of any one of embodiments B1-B14, wherein the first filtering area is one of: a coding unit, CU, a coding tree unit, CTU, a slice, a tile or a patch for the NN-based filtering.

B16. The method of any one of embodiments B1-B15, wherein
encoding the picture, the filtering information, and the filtering area information comprises encoding the picture, the filtering information, and the filtering area information, and another filtering information about a second NN based filtering,
the second NN based filtering is different from the first NN based filtering, and
the filtering area information indicates a second filtering area to which the second NN based filtering is to be applied.

B17. The method of embodiment B16, wherein the filtering area information indicates that no NN-based filtering is to be applied to an area that is different from the first filtering area and the second filtering area.

B18. The method of any one of embodiments B1-B17, wherein the first NN based filtering is used for one or more of: visual quality improvement, providing a super-resolution, picture upsampling, and chroma format upsampling.

B19. The method of embodiment B4, wherein at least one of the second set of syntax elements and the third set of syntax elements is signaled in a compound SEI message (e.g., a scalable nesting SEI message).

C1. A computer program (900) comprising instructions (944) which when executed by processing circuitry (902) cause the processing circuitry to perform the method of any one of embodiments A1-B19.

C2. A carrier containing the computer program of embodiment C1, wherein the carrier is one of an electronic signal, an optical signal, a radio signal, and a computer readable storage medium.

D1. An apparatus (900) for processing a bitstream including a coded picture, the apparatus being configured to:
receive (s702) the bitstream;
decode (s704) the received bitstream including the coded picture, thereby obtaining i) a decoded picture, ii) filtering information about a first neural network, NN, based filtering, and iii) filtering area information indicating a first filtering area to which the first NN based filtering is to be applied; and
apply (s706) the first NN based filtering to the first filtering area in the decoded picture.

D2. The apparatus of embodiment D1, wherein the apparatus is configured to perform the method of any one of embodiments A2-A19.

E1. An encoder (900), the encoder being configured to:
obtain (s802) a picture;
obtain (s804) filtering information about a first neural network, NN, based filtering;
obtain (s806) filtering area information indicating a first filtering area within the picture, to which the first NN based filtering is to be applied; and
encode (s808) the picture, the filtering information, and the filtering area information, thereby generating a bitstream including a coded picture.

E2. The encoder of embodiment E1, wherein the encoder is configured to perform the method of any one of embodiments B2-B19.

F1. An apparatus (900) comprising:
a processing circuitry (902); and
a memory (941), said memory containing instructions executable by said processing circuitry, whereby the apparatus is operative to perform the method of any one of embodiments A1-B19.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for processing a bitstream including a coded picture, the method comprising:
receiving the bitstream;
decoding the received bitstream including the coded picture, thereby obtaining i) a decoded picture, ii) filtering information about a first neural network (NN) based filtering, and iii) filtering area information indicating a first filtering area to which the first NN based filtering is to be applied; and
applying the first NN based filtering to the first filtering area in the decoded picture; wherein:
the received bitstream includes a group of one or more syntax elements,
the group of one or more syntax elements indicates that the first NN based filtering is to be applied to a first part of the decoded picture but is not to be applied to a second part of the decoded picture,
the first filtering area corresponds to the first part of the decoded picture, and
the size of the first filtering area is different from the size of the decoded picture and the size of any subpicture included in the coded picture in the bitstream.

2. (canceled)

3. The method of claim 1, wherein
the received bitstream comprises a first set of syntax elements, a second set of syntax elements, and a third set of syntax elements, and
decoding the received bitstream comprises:
decoding the first set of syntax elements, thereby obtaining the decoded picture;
decoding the second set of syntax elements, thereby obtaining the filtering information; and
decoding the third set of syntax elements, thereby obtaining the first filtering area information.

4. The method of claim 3, wherein
the received bitstream comprises a first supplemental enhancement information (SEI) message and a second SEI message,
the second set of syntax elements is included in the first SEI message, and
the third set of syntax elements is included in the second SEI message.

5. The method of claim 4, wherein
the first SEI message is an NN post-filter characteristics SEI message, and
the second SEI message is an NN post-filter activation SEI message.

6. The method of claim 3, wherein the third set of syntax elements comprises the one or more syntax elements.

7. The method of claim 3, wherein
the received bitstream comprises a supplemental enhancement information (SEI) message, and
both the second set of syntax elements and the third set of syntax elements are included in the SEI message.

8. The method of claim 3, wherein
at least one of the second set of syntax elements and the third set of syntax elements is included in i) one or more parameter sets, ii) a header, or iii) a system layer,
the one or more parameter sets includes one or more of: a sequence parameter set, a picture parameter set, or an adaptive parameter set,
the header is a picture header or a slice header, and
the system layer is a part of transport protocol data or file format data.

9-19. (canceled)

20. A method performed by an encoder, the method comprising:
obtaining a picture;
obtaining filtering information about a first neural network (NN) based filtering;
obtaining filtering area information indicating a first filtering area within the picture, to which the first NN based filtering is to be applied; and
encoding the picture, the filtering information, and the filtering area information, thereby generating a bitstream including a coded picture, wherein
the method further comprises:
storing the bitstream in a storage medium of the encoder;
transmitting the bitstream towards a storage entity for storing the bitstream; and/or
transmitting the bitstream towards a decoder.

21. (canceled)

22. The method of claim 20, wherein
the bitstream includes a group of one or more syntax elements,
the group of one or more syntax elements indicates that the first NN based filtering is to be applied to a first part of a decoded picture but is not to be applied to a second part of the decoded picture, and
the first filtering area corresponds to the first part of the decoded picture.

23. The method of claim 20, wherein the size of the first filtering area is different from the size of a decoded picture and the size of any subpicture included in the coded picture in the bitstream.

24. The method of claim 20, wherein
the bitstream comprises a first set of syntax elements, a second set of syntax elements, and a third set of syntax elements,
the first set of syntax elements corresponds to the coded picture,
the second set of syntax elements corresponds to the filtering information, and
the third set of syntax elements corresponds to the first filtering area information.

25-32. (canceled)

33. A non-transitory computer readable storage medium storing a computer program comprising instructions which when executed by processing circuitry of an apparatus causes the apparatus to perform the method of claim 1.

34. A non-transitory computer readable storage medium storing a computer program comprising instructions which when executed by processing circuitry of an apparatus causes the apparatus to perform the method of claim 20.

35. An apparatus for processing a bitstream including a coded picture, the apparatus comprising:
memory; and
processing circuitry, wherein
the apparatus is configured to perform the method of claim 1.

36. An encoding apparatus, the encoding apparatus comprising:
memory; and
processing circuitry, wherein
the encoding apparatus is configured to perform the method of claim 20.
